(19) United States
(12) Patent Application Publication
(10) Pub. No.: US 2021/0095086 A1
(43) Pub. Date: Apr. 1, 2021

(54) CELLULOSE ESTER FILMS AND METHODS OF MAKING AND USING THE SAME

(71) Applicant: North Carolina State University, Raleigh, NC (US)

(72) Inventors: Marian G. McCord, Raleigh, NC (US); Lokendra Pal, Raleigh, NC (US); Mohamed A. Bourham, Raleigh, NC (US); Xiaohang Sun, Raleigh, NC (US)

(21) Appl. No.: 16/971,193

(22) PCT Filed: Feb. 22, 2019
(86) PCT No.: PCT/US2019/019190

§ 371 Date: Aug. 19, 2020

Related U.S. Application Data
(60) Provisional application No. 62/634,028, filed on Feb. 22, 2018.

(51) Int. Cl. C08J 7/04; C08J 7/12; B32B 37/14; B32B 38/00; G02B 5/30

(52) U.S. Cl. CPC C08J 7/0427; C08J 7/123; B32B 37/14; B32B 38/0008; B32B 2310/14; C08J 2301/12; C08J 2433/12; B32B 2038/0076; G02B 5/3083

(57) ABSTRACT

Films comprising a layer including a cellulose ester and a layer including an acrylic coating are provided. Polarizing sheets comprising the films are also provided. In addition, methods of making the films and polarizing sheets are provided.

### CROSS-REFERENCE TO RELATED APPLICATIONS

This application claims priority to U.S. Provisional Application No. 62/634,028, filed Feb. 22, 2018, which is hereby incorporated by reference in its entirety.

### TECHNICAL FIELD

This disclosure relates to hydrophobically treated cellulose ester films. The films can be used to protect existing films and articles such as polarizing sheets in liquid crystal displays.

### BACKGROUND

Cellulose ester films (e.g., cellulose triacetate (CIA) films, also called triacetyl cellulose (TAC)) are presently used in electronic displays, such as liquid crystal displays (LCDs). They can act as protectors for the polarizer and provide viewing angle compensation for the resultant displays. In the process of providing a polarizer, a dyed and oriented polyvinyl alcohol (PVA) sheet can be sandwiched between protective layers of CTA film since water, water vapor, and moisture can degrade and alter the active, oriented. PVA sheet with a subsequent loss in polarization efficiency. A reduction in water absorption and vapor transmission rates of cellulose ester films could potentially improve the life of a polarizer.

### SUMMARY

In some aspects, disclosed are films comprising a first material comprising a cellulose ester; and a second material comprising an acrylic coating, the second material applied to at least a portion of the first material, wherein the film has an optical in-plane retardation (Rₑ) of about 0.1 nm to about 2 nm and an out-of-plane retardation (Rₜₕ) of about −5 nm to about −75 nm measured at 598 nm.

In some aspects, disclosed are polarizing sheets comprising a layer comprising a polymer and iodine; and a film applied on at least a portion of the layer, the film comprising a first material comprising a cellulose ester, the first material having a surface and having a thickness of 5 μm to about 100 μm; and a second material comprising an acrylic coating and having a thickness of about 0.1 μm to about 25 μm, the second material applied to at least a portion of the first material's surface.

In some aspects, disclosed are methods of making a film, the method comprising plasma treating at least a portion of a first material comprising a cellulose ester with a plasma composition comprising an inert gas and a reactive gas to provide a plasma-treated surface; applying a composition to at least a portion of the plasma-treated surface, wherein the composition comprises an acrylic-based monomer and a polymerization initiator; and curing the composition to provide a second material comprising an acrylic coating positioned on the plasma-treated surface of the first material.

In some aspects, disclosed are methods of making a film, the method comprising applying a composition comprising an acrylic-based monomer and a polymerization initiator to a first material comprising a cellulose ester; and plasma treating the composition and the first material to provide a second material comprising an acrylic coating applied to at least a portion of the first material.

In some aspects, disclosed are methods of making a polarizing sheet, the method comprising plasma treating at least a portion of a first material comprising a cellulose ester with a plasma composition comprising an inert gas and a reactive gas to provide a plasma-treated surface; applying a composition to at least a portion of the plasma-treated surface, wherein the composition comprises an acrylic-based monomer and a polymerization initiator; curing the composition and the first material to produce a film; laminating the film and a layer comprising a polymer and iodine to provide a polarizing sheet.

### BRIEF DESCRIPTION OF THE DRAWINGS

FIG. 1 is a schematic of a polarizing sheet.

FIG. 2A is a schematic of an atmospheric pressure glow discharge plasma system, and FIG. 2B is a photograph of an atmospheric pressure glow discharge plasma system that can be used in the disclosed methods.

FIG. 3 is a schematic and photograph of a rod coating process.

FIG. 4 is a schematic of a procedure for rod coating and curing of acrylic resin onto a CTA film.

FIG. 5 is a schematic of water vapor transmission testing with one-side treated film loaded on an aluminum cup with the treated side facing inside and outside of the cup.

FIG. 6 is a plot showing contact angle of CET plasma treated CTA films.

FIG. 7 is a plot showing the water vapor transmission rate (WVTR) of CTA films with different reactive gases as a function of treatment time.

FIG. 8 is a plot showing the WVTR of O₂ plasma treated CTA films as a function of treatment time.

FIG. 9 is a plot showing the effect of power output on WVTR of O₂ plasma treated CTA films.

FIG. 10 is a plot showing the XPS spectra of carbon and oxygen content of a non-plasma treated CTA film.

FIG. 11 is a plot showing the XPS spectra of carbon and oxygen content for an O₂ treated CTA

FIG. 12 is a plot showing the XPS spectra of carbon and oxygen content for a C₃F₆ plasma treated CTA film.

FIG. 13 is a plot showing the high-resolution C1s XPS spectra of a non-plasma treated CTA film.

FIG. 14 is a plot showing the high-resolution C1s XPS spectra of an O₂ treated CTA film.

FIG. 15 is a plot showing the high-resolution C1s XPS spectra of a C₃F₆ plasma treated CTA film.

FIG. 16A is a plot showing the high-resolution C1s XPS spectra of an untreated CTA film. FIG. 16B is a plot showing the high-resolution C1s XPS spectra of an O₂ treated CTA film. FIG. 16C is a plot showing the high-resolution C1s XPS spectra of a C₃F₆ treated CTA film. FIG. 16D is plot showing the high-resolution C1s XPS spectra of a C₃F₆ treated then O₂ treated CTA film. FIG. 16E is plot showing the high-resolution C1s XPS spectra of an O₂ treated then C₃F₆ treated CTA film.

FIG. 17 is a plot showing the high-resolution C1s XPS spectra of an O₂ treated and acrylic coated CTA film.

FIG. 18 is a plot showing predicted overall WVTR as a function of acrylic layer thickness.

FIG. 19 is a plot showing thickness change of untreated and an acrylic coated film with water immersion test.

FIG. 20 is a schematic showing a plasma treated and acrylic coated film.

FIG. 21 is a schematic showing a plasma treated and acrylic coated film.

FIG. 22 is a schematic showing a plasma treated and acrylic coated film.

FIG. 23 is a schematic showing a plasma treated and acrylic coated film,

FIG. 24 is a schematic showing a plasma treated and acrylic coated film.

FIG. 25 is a plot showing adhesion strength of different films.

FIG. 26 is a plot showing the effect of O₂ plasma treatment on adhesion of films to polyvinyl alcohol (PVA).

FIG. 27 is a plot showing the effect of power output of O₂ plasma treatment on adhesion of CTA films to PVA.

FIG. 28 is a plot showing the effect of O₂ plasma treatment on adhesion of films to PVA.

FIG. 29 is a plot of high-resolution C1s XPS spectra of a saponified CTA film.

FIG. 30 is a plot showing adhesion strength of different films.

FIG. 31 is a plot showing adhesion strength of saponified and plasma treated/saponified films.

FIG. 32 is a plot showing the effect of peel rate on adhesion force for untreated films.

FIG. 33 is a plot showing the adhesion strength of different films to pressure sensitive adhesive.

FIG. 34 is a plot showing the adhesion strength of different films to pressure sensitive adhesive.

FIG. 35 is a plot showing adhesion strength of different films to pressure sensitive adhesive.

FIG. 36 is a plot showing the effect of film treatment on adhesion to pressure sensitive adhesive.

FIG. 37 is a plot showing light transmittance of an untreated film.

FIG. 38 is a plot showing light transmittance of a plasma treated film.

FIG. 39 is a plot showing WVTR of different films.

FIG. 40 is a plot showing WVTR of polarizing sheets.

FIG. 41 is a plot showing light transmittance of acrylic coatings using varying polymerization initiators.

FIG. 42 is a photograph of acrylic coatings using varying acrylic-based monomers.

### DETAILED DESCRIPTION

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

The term “acrylic-based monomer,” as used herein refers to a monomer that comprises at least one acryloyl functional group or at least one alkaacryloyl functional group as defined herein. Examples of acrylic-based monomers include, but are not limited to, methyl acrylate, ethyl acrylate, propyl acrylate, ethylene glycol diacrylate, propylene glycol diacrylate, trimethylolpropane triacrylate, pentaerythritol triacrylate, pentaeiythriol tetraacrylate, di-trimethylolpropane tetraacrylate, dipentaerythritol pentaacrylate, methacrylate, methacrylate dimethacrylate, di(ethylene glycol) dimethacrylate, triethylene glycol dimethacrylate, methyl methacrylate, ethyl methacrylate, hydroxyethyl methacrylate, and hydroxypropyl methacrylate.

The term “acrylic coating,” as used herein refers to a coating comprising polymer(s) and/or oligomers(s) derived from an acrylic-based monomer as defined herein. The acrylic coating may comprise acrylic-based monomer(s) that have not been incorporated into a polymer or oligomer. In addition, the acrylic coating may comprise residual amount of polymerization initiator, if such an initiator is used to provide the acrylic coating.

The term “acryloyl functional group,” as used herein refers to an unsaturated ester or acid functionality (e.g., H₂C═CHC(O)—O—).

The term “alkaacryloyl functional group,” as used herein refers to an alkyl substituted α,β-unsaturated ester or acid functionality (e.g., H₂C═CRC(O)—O—, wherein R is an alkyl group).

The term “alkyl” as used herein, means a straight or branched, saturated hydrocarbon chain containing from 1 to 10 carbon atoms. The term “lower alkyl” or “C₁-C₆-alkyl” means a straight or branched chain hydrocarbon containing from 1 to 6 carbon atoms. The term “C₁-C₃-alkyl” means a straight or branched chain hydrocarbon containing from 1 to 3 carbon atoms. Representative examples of alkyl include, but are not limited to, methyl, ethyl, n-propyl, iso-propyl, n-butyl, sec-butyl, iso-butyl, tent-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “cellulose ester,” as used herein, refers to organic acid esters of cellulose. The term refers to the condensation product from the reaction of a hydroxyl group on the cellulose with the carboxylic acid group of a carboxylic acid with the formation of water as a co-product. The cellulose ester may be randomly or regioselectively substituted. The cellulose ester may have the formula:

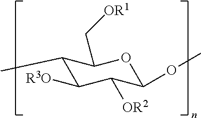

wherein R¹, R², and R³ may each be selected independently from the group consisting of hydrogen or a straight chain alkanoyl having from 2 to 10 carbon atoms, and n is about 100 to about 5000. Examples of cellulose esters include, but are not limited to, cellulose acetate, cellulose triacetate, cellulose propionate, cellulose acetate propionate, cellulose acetate butyrate, cellulose tripropionate, cellulose butyrate, and cellulose tributyrate.

### 2. FILMS

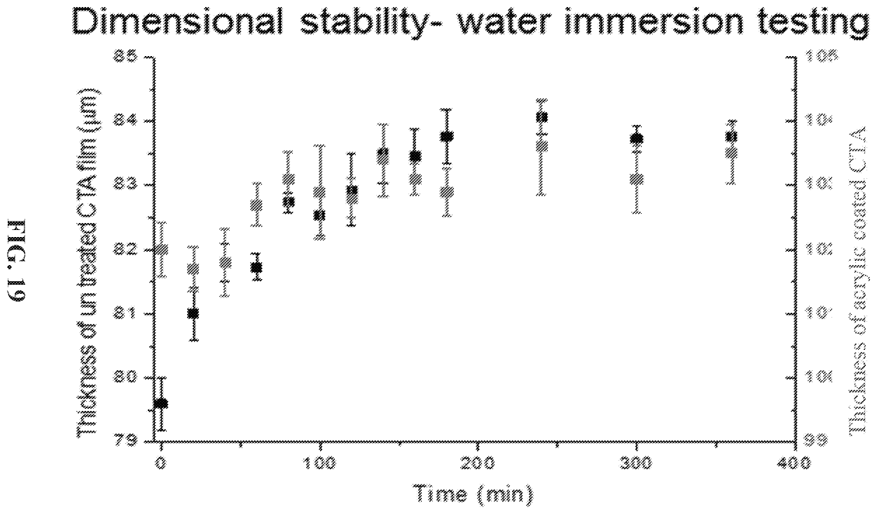

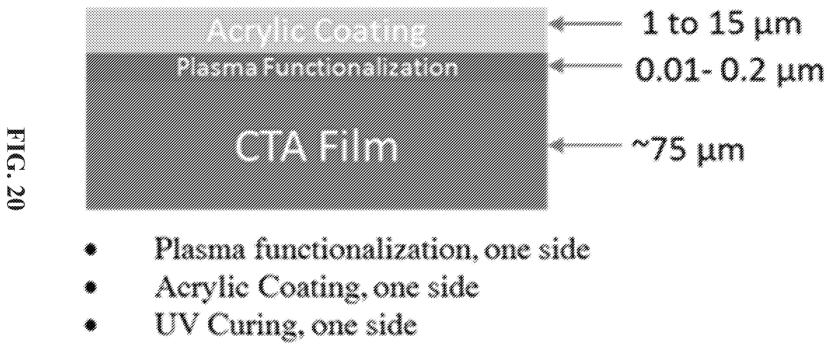

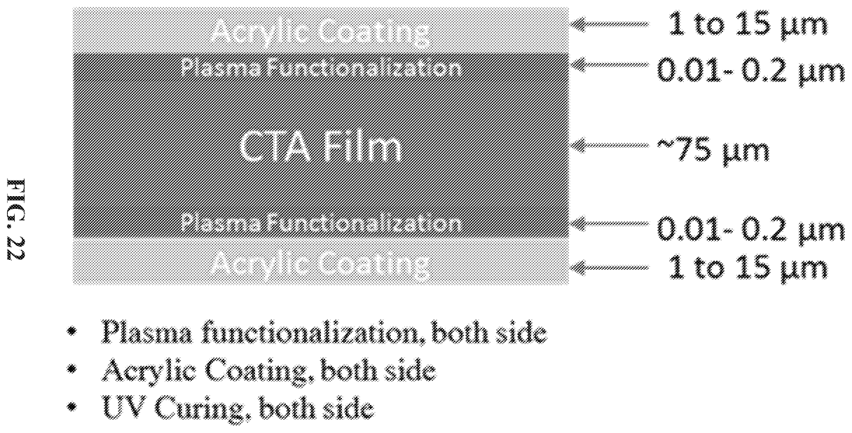

Disclosed herein are films that have useful water resistant properties, e.g., having low water vapor transmission rates. The films may comprise one or more of a first material, a second material, and optionally a third material. Each material may be in the form of a layer. For example, the films may have a multi-layer structure (see, e.g., FIGS. 21-25). The film may, for example, include a first layer, a second layer, and optionally a third layer. Each layer may have at least a first surface and a second surface. The first layer may have a first surface and a second surface, and the second layer may have a first surface and a second surface. The first and second surfaces of each layer may be on opposing sides of the individual respective layer. For example, in some embodiments, the first surface of the first layer may be a top surface of the first layer. Accordingly, in these embodiments, the second layer on the opposing side of the first layer relative to the top surface would be the bottom surface of the first layer.

The first and second layers may be positioned in varying arrangements. In some embodiments, the second layer may be positioned on at least a portion of the first surface of the first layer. In other embodiments, the second layer may be positioned on at least a portion of the second surface of the first layer. Further, in some embodiments, the first layer may be positioned on a portion of the first surface of the second layer. In other embodiments, the first layer may be positioned on a portion of the second surface of the second layer.

The film may include the first and second layers at varying ratios. For example, the first layer and second layer may be included at a ratio of about 75:0.5 to about 75:25 (by weight %), such as about 75:1 to about 75:20 or about 75:5 to about 75:15 (by weight %).

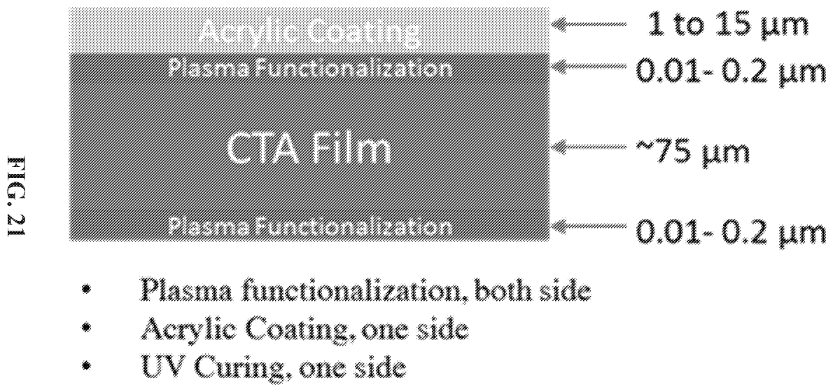

The film may further include a third layer. The third layer may be the same and/or similar as the second layer as described herein. In embodiments where a third layer is present, the first layer may be positioned in between the second and third layers (see, e.g., FIG. 23). For example, the second layer may be positioned on at least a portion of the first surface of the first layer, and the third layer may be positioned on at least a portion of the second surface of the first layer. In some embodiments, the second and third layers do not directly contact each other.

The films can be used as a coating on and/or within water-sensitive materials. For example, the films may be used in electronic displays (e.g., liquid crystal displays). In some embodiments, the films may be used as part of a polarizing sheet within an electronic display.

A. First Material

The first material may comprise a cellulose ester. The cellulose ester may include any cellulose ester that can have enhanced properties (e.g., enhanced water barrier properties) due to being plasma treated. Examples of cellulose esters include, but are not limited to, cellulose acetate, cellulose triacetate, cellulose propionate, cellulose acetate propionate, cellulose acetate butyrate, cellulose tripropionate, cellulose butyrate, cellulose tributyrate, and combinations thereof.

In some embodiments, the first layer may be a cellulose ester. In some embodiments, the cellulose ester may be cellulose triacetate (CTA). CTA can range in acetyl substitution from approximately 2.4 to 3 substitution points on the cellulose backbone. CTA sheets for electronics such as LCDs may be made with substitution in the range of 2.8 to 2.9. This degree of acetyl substitution may result in useful properties (such as clarity, physical strength, and polymer solubility).

As mentioned above, the first material may be in the form of a layer (e.g., a first layer) having a first surface and a second surface. The first and/or second surface of the first layer may be plasma treated, which as described herein can instill advantageous properties relative to a layer that has not been plasma treated. The first surface (and/or second surface) of the first layer may have a ratio of carbon atoms to oxygen atoms of greater than or equal to 2:1, greater than or equal to 2.1:1, greater than or equal to 2.2:1, greater than or equal to 2.3:1, greater than or equal to 2.4:1, greater than or equal to 2.5:1, greater than or equal to 2.6:1, greater than or equal to 2.7:1, or greater than or equal to 2.8:1.

Each of the first surface and second surface may, independently, have greater than or equal to 35% carbon with C—C bonds, greater than or equal to 36% carbon with C—C bonds, greater than or equal to 37% carbon with C—C bonds, greater than or equal to 38% carbon with C—C bonds, greater than or equal to 39% carbon with C—C bonds, greater than or equal to 40% carbon with C—C bonds, greater than or equal to 41% carbon with C—C bonds, greater than or equal to 42% carbon with C—C bonds, greater than or equal to 43% carbon with C—C bonds, greater than or equal to 44% carbon with C—C bonds, greater than or equal to 45% carbon with C—C bonds, greater than or equal to 46% carbon with C—C bonds, or greater than or equal to 47% carbon with C—C bonds.

Each of the first surface and second surface may, independently, have less than or equal to 45% carbon with C—O bonds, less than or equal to 44% carbon with C—O bonds, less than or equal to 43% carbon with C—O bonds, less than or equal to 42% carbon with C—O bonds, less than or equal to 41% carbon with C—O bonds, less than or equal to 40% carbon with C—O bonds, less than or equal to 39% carbon with C—O bonds, less than or equal to 38% carbon with C—O bonds, less than or equal to 37% carbon with C—O bonds, or less than or equal to 36% carbon with C—O bonds.

Each of the first surface and second surface may, independently, have less than or equal to 24% carbon with C═O bonds, less than or equal to 23% carbon with C═O bonds, less than or equal to 22% carbon with C═O bonds, less than or equal to 21% carbon with C═O bonds, less than or equal to 20% carbon with C═O bonds, less than or equal to 19% carbon with C═O bonds, less than or equal to 18% carbon with C═O bonds, or less than or equal to 17% carbon with C═O bonds.

In some embodiments, the first surface, the second surface, or both may have greater than or equal to 35% carbon with C—C bonds, less than or equal to 40% carbon with C—O bonds, and less than or equal to 20% carbon with C═O bonds. In some embodiments, the first surface, the second surface or both does not include fluorine.

The first material may be present at varying thicknesses. For example, the first material may have a thickness of about 5 μm to about 100 μm, such as about 10 μm to about 90 μm or about 15 μm to about 80 μm. In some embodiments, the first material may have a thickness of greater than 5 μm, greater than 10 μm, greater than 20 μm, greater than 30 μm, greater than 40 μm, or greater than 50 μm. In some embodiments, the first material may have a thickness of less than 100 μm, less than 95 μm, less than 90 μm, less than 85 μm, or less than 80 μm.

B. Second Material

The second material may comprise an acrylic coating. The acrylic coating may include an acrylic-based monomer, an oligomer that is derived from the acrylic-based monomer, a polymer derived from the acrylic-based monomer, or combinations thereof. The acrylic-based monomer may include a mono-functional acrylic-based monomer, a di-functional acrylic-based monomer, a tri-functional acrylic-based monomer, a polyfunctional acrylic-based monomer, or combinations thereof.

The acrylic-based monomer may have a plurality of acryloyl functional groups, alkaacryloyl functional groups, or both such as about 2 to about 8 acryloyl and/or alkaacryloyl functional groups, about 2 to about 6 acryloyl and/or alkaacryloyl functional groups, or about 2 to about 4 acryloyl and/or alkaacryloyl functional groups. In some embodiments, the acrylic-based monomer has about 2 acryloyl and/or alkaacryloyl functional groups, about 3 acryloyl and/or alkaacryloyl functional groups, or about 4 acryloyl and/or alkaacryloyl functional groups.

Examples of acrylic-based monomers include, but are not limited to, methyl acrylate, ethyl acrylate, propyl acry late, ethylene glycol diacrylate, propylene glycol diacrylate, trimethylolpropane triacry late, pentaerythritol triacrylate, pentaerythriol tetraacrylate, di-trimethylolpropane tetraacrylate, dipentaerythritol pentaacrylate, methacrylate, methacrylate dimethacrylate, di(ethylene glycol) dimethacrylate, triethylene glycol dimethacrylate, methyl methacrylate, ethyl methacrylate, hydroxyethyl methacrylate, hydroxypropyl methacrylate and combinations thereof.

In some embodiments, the acrylic coating may include a polymer, oligomer or both derived from at least one monomer selected from the group consisting of methyl acrylate, ethyl acrylate, propyl acrylate, ethylene glycol diacrylate, propylene glycol diacrylate, trimethylolpropane triacrylate, pentaerythritol triacrylate, pentaerythriol tetraacrylate, di-trimethylolpropane tetraacrylate, dipentaerythritol pentaacrylate, methacrylate, methacrylate dimethacrylate, di(ethylene glycol) dimethacrylate, triethylene glycol dimethacrylate, methyl methacrylate, ethyl methacrylate, hydroxyethyl methacrylate, and hydroxypropyl methacrylate. Further to the function of monomers, ethylene glycol diacrylate, propylene glycol diacrylate, trimethylolpropane triacrylate, pentaerythritol triacrylate, pentaerythriol tetraacrylate, di-trimethylolpropane tetraacrylate, and dipentaerythritol pentaacrylate can be used as a crosslinking agent if mixed with other acrylate monomers. In addition, in some embodiments, there may be a residual amount of polymerization initiator, if such an initiator is used to provide the acrylic coating.

As mentioned above, the second material may be in the form of a layer e.g., a second layer) having a first surface and a second surface, and may be positioned on a portion of the first or the second surface of the first layer. In some embodiments, the second layer may be positioned on the first surface (or the second surface) of the first layer, covering the entirety of the first surface (or the second surface) of the first layer. In some embodiments, the second layer may be an acrylic coating.

The second material may be present at varying thicknesses. For example, the second material may have a thickness of about 0.1 μm to about 25 μm, such as about 0.5 μm to about 25 μm, about 1 μm to about 20 μm, about 2 μm to about 10 μm, or about 3 μm to about 8 μm. In some embodiments, the second material may have a thickness of greater than 0.5 μm, greater than 1 μm, greater than 1.5 μm, greater than 2 μm, greater than 2.5 μm, or greater than 3 μm. In some embodiments, the second material may have a thickness of less than 25 μm, less than 20 μm, less than 15 μm, less than 12 μm, or less than 10 μm.

C. Third Layer

The film may also include a third material that may be in the form of a third layer. Generally, the above-description regarding the second material is applicable to the third material. The second and third material or second and third layers, however, may or may not be the same. For the purposes of brevity, this description will not be repeated here. The first, second and/or third materials or layers may be in direct contact with one another (e.g., as shown in FIGS. 21-25). In other embodiments, there may be other materials or layers therein between.

D. Properties of the Films

The disclosed films possess many advantageous properties that make them useful for a variety of different applications; some of these properties are listed below.

1) Water Vapor Transmission Rate

Water vapor transmission rate (WVTR) is a measure of how much water vapor can pass through a material per unit area per unit time. Accordingly, WVTR can be a measurement of water permeability. WVTR can be measured according to the ASTM E-96 wet cup method. For example, the Vapometer, model 68-3000 (2″ EZ-Cup) from Thwing-Albert Instrument Company, can be used to determine the water vapor permeability of the disclosed films.

The film may have a WVTR of about 1 g/day/m² to about 65 g/day/m², such as about 5 g/day/m² to about 50 g/day/m² or about 7 g/day/m² to about 40 g/day/m². In some embodiments, the film may have a WVTR of less than or equal to 65 g/day/m², less than or equal to 60 g/day/m², less than or equal to 55 g/day/m², less than or equal to 50 g/day/m², less than or equal to 45 g/day/m², or less than or equal to 40 g/day/m². In some embodiments, the film may have a WVTR of greater than or equal to 1 g/day/m², greater than or equal to 2 g/day/m², greater than or equal to 3 g/day/m², greater than or equal to 4 g/day/m², greater than or equal to 5 g/day/m², or greater than or equal to 6 g/day/m².

2) Optical Properties

The film may have useful optical properties that are comparable to a cellulose ester film that has not been plasma treated and/or had an acrylic coating applied thereto. In other words, the films may have advantageous properties, such as enhanced WVTR, without limiting the optical properties of the film. For example, the film may have an optical in-plane retardation (Rₑ) of about 0.1 nm to about 2 nm measured at 589 nm, such as about 0.9 nm to about 1.1 nm, 0.91 nm to about 1.08 nm or about 0.95 nm to about 1.06 nm measured at 589 nm. In addition, the film may have an out-of-plane retardation (Rₜₕ) of about −5 nm to about −75 nm measured at 589 nm, such as about −30 nm to about −50 nm, about −32 nm to about −49 nm or about −40 nm to about −50 nm measured at 589 nm.

In addition, the films may have a light transmittance percentage at 450 nm, 550 nm, and/or 650 nm of greater than or equal to 85%, greater than or equal to 86%, greater than or equal to 87%, greater than or equal to 88%, greater than or equal to 89%, or greater than or equal to 90%. In some embodiments, the film may have a light transmittance percentage at 450 nm, 550 nm, and/or 650 nm of about 85% to about 99%.

3) Contact Angle

Contact angle measurements can be used to assess the hydrophobicity, hydrophilicity, or both of the surface(s) of the film or layers thereof. The film may have a contact angle of about 20° to about 90°, such as about 40° to about 80° or about 45° to about 70°. In some embodiments, the film may have a contact angle of greater than or equal to 20°, greater than or equal to 25°, greater than or equal to 30°, greater than or equal to 55° or greater than or equal to 40°. In some embodiments, the film may have a contact angle of less than or equal to 90°, less than or equal to 85°, less than or equal to 80°, less than or equal to 75° or less than or equal to 70°.

4) Dimensional Stability

The disclosed films may have improved dimensional stability. Dimensional stability as used herein refers to a film being able to maintain its physical dimensions, e.g., within ±3% after being exposed to moisture for a period of time (e.g., from about 20 minutes to about 360 minutes). The thickness may be measured at 3, 4. 5 or 6 different locations on the film after a period of time following exposure to moisture and then averaged to provide an average thickness after exposure to moisture. This may then be compared to the average thickness of the film prior to exposure to moisture.

The film may have an increased average thickness of about 0.1% to about 2.5% after being exposed to moisture for about 1 minute to about 360 minutes, such as about 0.2% to about 2% or about 0.3% to about 1.5% after being exposed to moisture for about 1 minute to about 360 minutes. In some embodiments, the film may have an increased average thickness of greater than 0.1%, greater than 0.2%, greater than 0.3%, greater than 0.4%, or greater than 0.5% after being exposed to moisture for about 1 minute to about 360 minutes. In some embodiments, the film may have an increased average thickness of less than 2.5%, less than 2.0%, less than 1.9%, less than 1.8%, or less than 1.7% after being exposed to moisture for about 1 minute to about 360 minutes.

5) Adhesion

The disclosed films may exhibit useful adhesion properties to the surfaces of other materials, such as to the surface of a polyvinyl alcohol film, a pressure sensitive adhesive (PSA), or both. The adhesion of the film to PSA may be measured by a T-Peel adhesion test (ASTM D1876) using, e.g., an Instron 4443 tensile tester. In addition, the adhesion of the film to a PVA film or polarizing film may be measured by a 90° peel test (ASTM D3330) using, e.g., an Instron 4443 tensile tester.

The film may have an adhesion force to PSA of about 0.1 N to about 0.25 N as measured by ASTM D1876, such as about 0.125 N to about 0.2 N or about 0.15 N to about 0.19 N as measured by ASTM D1876. In some embodiments, the film may have an adhesion force to PSA of greater than or equal to 0.1 N, greater than or equal to 0.125 N, greater than or equal to 0.15 N, or greater than or equal to 0.16 N as measured by ASTM D1876. In some embodiments, the film may have an adhesion force to PSA of less than or equal to 0.25 N, less than or equal to 0.22 N, less than or equal to 0.195 N, or less than or equal to 0.19 N as measured by ASTM D1876.

### 3. METHODS OF MAKING THE FILMS

Also disclosed herein are methods of making the films. The methods may include plasma treating one or more of the first, second or third materials. For example, one or more of the following may be plasma treated: the first surface of the first layer, the second surface of the first layer, the first surface of the second layer, the second surface of the second layer, the first surface of the third layer, the second surface of the third layer, and combinations thereof.

Additionally, the film itself may be plasma treated. For example, at least a portion of a first surface of the film comprising the first material may be plasma treated. In some embodiments, at least portion of the first layer may be plasma treated prior to application of the composition (from which the second material is derived from). In some embodiments, a portion of the first and a portion of a second surface of the film may be plasma treated. In some embodiments, the entirety of the first surface of the film comprising a cellulose ester, the second surface of the film comprising a cellulose ester, or both may be plasma treated.

Plasma compositions comprising an inert gas and a reactive gas may be used for plasma treating in order to provide a plasma-treated surface. Examples of the inert gas include, but are not limited to, helium, argon, and combinations thereof. In addition, examples of the reactive gas include, but are not limited to, oxygen, nitrogen, hydrogen, ammonia, acetylene, tetrafluoromethane (CF₄), hexafluoropropylene (C₃F₆) and combinations thereof. In some embodiments, the inert gas may be helium and the reactive gas may be oxygen. In some embodiments, the plasma treatment may be performed at atmospheric pressure.

The plasma treatment can use varying amounts (and varying flow rates) of the inert gas and the reactive gas. For example, the ratio of flow rate for the inert gas to the reactive gas may be about 5:1 to about 800:1, such as about 10:1 to about 700:1 or about 15:1 to about 600:1. In addition, the reactive gas flow rate during plasma treating may be about 0.05 L/min to about 2 L/min, such as about 0.1 L/min to about 1.5 L/min or about 0.15 L/min to about 1.2 L/min. In some embodiments, the reactive gas flow rate during plasma treating may be greater than or equal to 0.05 L/min, greater than or equal to 0.07 L/min, greater than or equal to 0.09 L/min, or greater than or equal to 0.1 L/min. In some embodiments, the reactive gas flow rate during plasma treating may be less than or equal to 2 L/min, less than or equal to 1.8 L/min, less than or equal to 1.5 L/min, or less than or equal to 1.2 L/min.

The plasma treatment can be performed for varying amounts of time. For example, the plasma treatment may be performed for about 5 seconds to about 15 minutes, such as for about 10 seconds to about 14 minutes or for about 15 seconds to about 12 minutes. In some embodiments, the plasma treatment may be performed for greater than or equal to 10 seconds, greater than or equal to 1 minute, or greater than or equal to 2 minutes. In some embodiments, the plasma treatment may be performed for less than or equal to 15 minutes, less than or equal to 14 minutes, or less than or equal to 13 minutes.

The plasma treatment can be performed at various frequencies. For example, the plasma treatment may be performed at about 1 kHz to about 10 kHz, such as about 1.5 kHz to about 5 kHz. In some embodiments, the plasma treatment may be performed at greater than or equal to 1 kHz, greater than or equal to 1.5 kHz, or greater than or equal to 5 kHz.

In addition, plasma treatment may be performed at varying power outputs. For example, plasma treatment may be performed at a power of about 25 W to about 250 W, such as about 30 W to about 225 W or about 35 W to about 210 W. In some embodiments, plasma treatment may be performed at a power of greater than or equal to 100 W, greater than or equal to 110 W, greater than or equal to 120 W, greater than or equal to 130 W, or greater than or equal to 140 W. In some embodiments, plasma treatment may be performed at a power of less than or equal to 225 W, less than or equal to 220 W, less than or equal to 215 W, less than or equal to 210 W, or less than or equal to 205 W.

Plasma treating at least a portion of the first material may increase crystallinity relative to a portion that has not been plasma treated. For example, the plasma-treated first material may have an increase in crystallinity of at least 0.5%, at least 1%, at least 1.5%, at least 2%, at least 2.5%, at least 3%, at least 3.5%, at least 4%, at least 4.5%, or at least 5% relative to a first material that has not been plasma treated.

Following plasma treating the first material, a composition may be applied to at least a portion of the plasma-treated first material. The composition may include an acrylic-based monomer as described above. In embodiments in which at least a portion of both the first and the second surfaces of the first layer are plasma treated, the composition may be applied to at least a portion of both the plasma-treated first surface and the plasma-treated second surface, or the composition can be applied to one of the plasma-treated surfaces.

The composition may also include a polymerization initiator. The initiator can be any compound that can generate free radicals upon exposure to an external stimulus (e.g., a light source, a plasma treatment, or both) and cause the polymerization of the acrylic-based monomer. In some embodiments, the initiator may be a photoinitator. Examples of initiators include but are not limited to, diphenyl(2,4,6-trimethylbenzoyl)phosphine oxide (TPO), 2-Hydroxy-2-methylpropiophenone, 1 -Hydroxycyclohexyl phenyl ketone, (2-Hydroxy-1-[4-(2-hydroxyethoxy)phenyl]-2-methyl-1-propanone), methylbenzoylformate, phenylbis(2,4,6-trimethylbenzoyl)phosphine oxide, and (4-methylphenyl) [4-(2-methylpropyl)phenyl]iodonium hexafluorophosphate. In some embodiments, the initiator may be 2-Hydroxy-2-methylpropiophenone.

In addition, the composition may have a varying viscosity prior to application. In some embodiments, the composition may be pre-polymerized to control viscosity, shrinkage and/or curing rate of the composition prior to application. The composition may have a viscosity of about 10 cP to about 1000 cP at 20° C., such as about 20 cP to about 900 cP or about 50 cP to about 800 cP at 20° C. In some embodiments, the composition may have a viscosity of greater than or equal to 10 cP at 20° C., greater than or equal to 25 cP at 20° C., greater than or equal to 50 cP at 20° C., greater than or equal to 100 cP at 20° C., or greater than or equal to 200 cP at 20° C. In some embodiments, the composition may have a viscosity of less than or equal to 1000 cP at 20° C., less than or equal to 950 cP at 20° C., less than or equal to 900 cP at 20° C., less than or equal to 850 cP at 20° C., or less than or equal to 800 cP at 20° C.

The composition may be applied to at least a portion of the surface of the plasma-treated first material by a variety of methods. For example, the composition may be applied by a glass rod, a Mayer rod coater, a blade coater, a roll coater, a spray coater, a spin coater, a curtain coater, a dip coater, a gravure coater, a flexo coater, or a combination thereof. In addition, these methods may be used to apply the composition to a non-plasma treated surface.

After the composition has been applied to at least a portion of the plasma-treated surface, the composition may be cured, for example, via ultraviolet (UV) light. In some embodiments, UV curing the composition may provide a film comprising the second material (which comprises an acrylic coating) positioned on the plasma-treated first material. UV curing can be performed using a 385 nm UV light and can be performed for varying amounts of time, such as for less than or equal to 15 seconds, less than or equal to 14 seconds, less than or equal to 13 seconds, less than or equal to 12 seconds, less than or equal to 11 seconds, or less than or equal to 10 seconds. In some embodiments, UV curing can be performed using a 385 nm UV light for about 1 second to about 15 seconds.

The disclosed methods may also include applying the composition to at least a portion of a surface of the first material prior to plasma treatment. Plasma treatment may then be subsequent. In these embodiments, the plasma treatment may serve two functions: 1) plasma treating the surface of the layer comprising the cellulose ester (or at least a portion thereof) and 2) curing the composition to provide the second material which includes an acrylic coating.

For example, in one aspect disclosed is a method that includes applying a composition to at least a portion of a surface of the first material to provide a film, wherein the composition comprises an acrylic-based monomer and a polymerization initiator, and the first material comprises a cellulose ester; and plasma treating the film to provide an acrylic coating positioned on at least a portion of the first surface of the first layer. Plasma treating and curing the composition (in situ) may provide improved process parameters, such as over-all method time.

### 4. USES OF THE FILMS

Also disclosed herein are uses of the films. As mentioned above, the disclosed films have useful properties, such as low water vapor transmission rate and advantageous optical and mechanical properties. These properties allow the disclosed films to be used in polarizing films/sheets.

A. Polarizing Sheet

A polarizing sheet is a key component of an LCD. Its function is to polarize light penetrating through the sheet. This allows liquid crystal displays to utilize polarized light combined with the twisted feature of the liquid crystal molecule to control whether the light passes or not and to determine the displaying performance. The market and performance requirements are rapidly increasing for LCDs for electronic equipment such as computer screens, smart phones, televisions, and even outside large display boards.

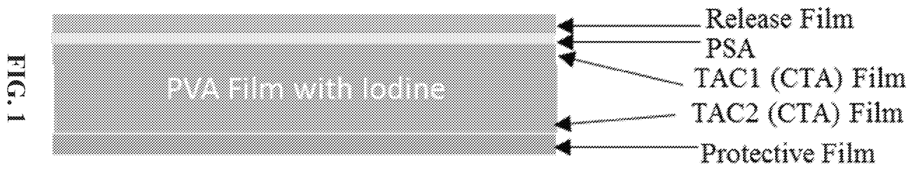

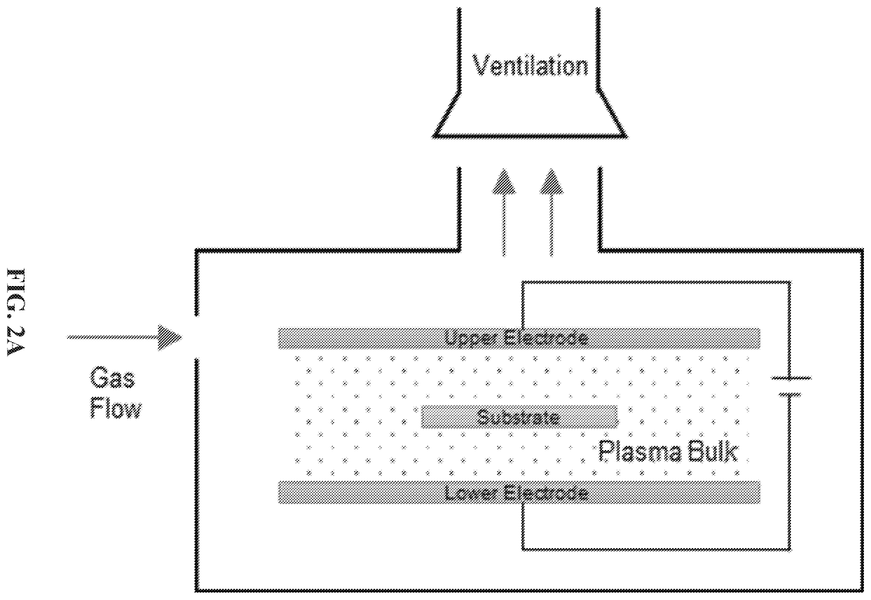

A schematic of a polarizing sheet is shown in FIG. 1. This process may comprise a polymer (e.g. polyvinyl alcohol) film with iodine and two TAC (also referred to CTA) films respectively applied on two sides of the PVA film. In addition, the polarizing sheet may further include a pressure-sensitive adhesive (PSA) film adhering to another side of one of the TAC films opposite to the PVA film, a release film adhering to another side of the PSA film opposite to a TAC film, and a surface protection film adhering to a TAC film opposite to the PVA film.

In one aspect, the disclosed films may be used as part of a polarizing sheet and methods of making the polarizing sheet. For example, the polarizing sheet may comprise the disclosed film as described above applied to a layer comprising a polymer and iodine. The term “applied,” as used throughout, may mean direct or indirect application. The film and this layer may be laminated. The method may further include laminating a fourth material to the polymer/iodine layer opposite of the film. The fourth material may be a second film having some or all of the properties of the disclosed film as describe above. The method may further include laminating an adhesive film onto a surface of the film, laminating a release film onto a surface of the adhesive film, laminating a protective film onto a surface of the fourth material, or a combination thereof. Accordingly, in some embodiments, the polarizing sheet may further include an adhesive film positioned on at least a portion of a surface of the film.

In addition, the film may be positioned in varying arrangements on the polymer/iodine layer. For example, the acrylic coating layer of the film may be positioned on at least a portion of a surface of the polymer/iodine layer. In other embodiments, the cellulose ester layer of the film may be positioned on at least a portion of a surface of the polymer/iodine layer.

### 5. EXAMPLES

### Materials & Methods for Examples 1 & 2

Materials: CTA film was provided by Eastman. The helium and oxygen gases used in the atmospheric plasma systems as working and reactive gasses were procured from Airgas. The Methyl methacrylate monomer (99%, stabilized) and the diphenyl (2,4,6-trimethylbenzoyl) phosphine oxide (TPO) photo-initiator were obtained from Sigma-Aldrich. A UV curable acrylic resin including methyl methacrylate monomer, diphenyl (2,4,6-trimethylbenzoyl) phosphine oxide (TPO) photo-initiator, and diacrylate crosslinker was obtained from Colorado Photopolymer Solutions (CPS).

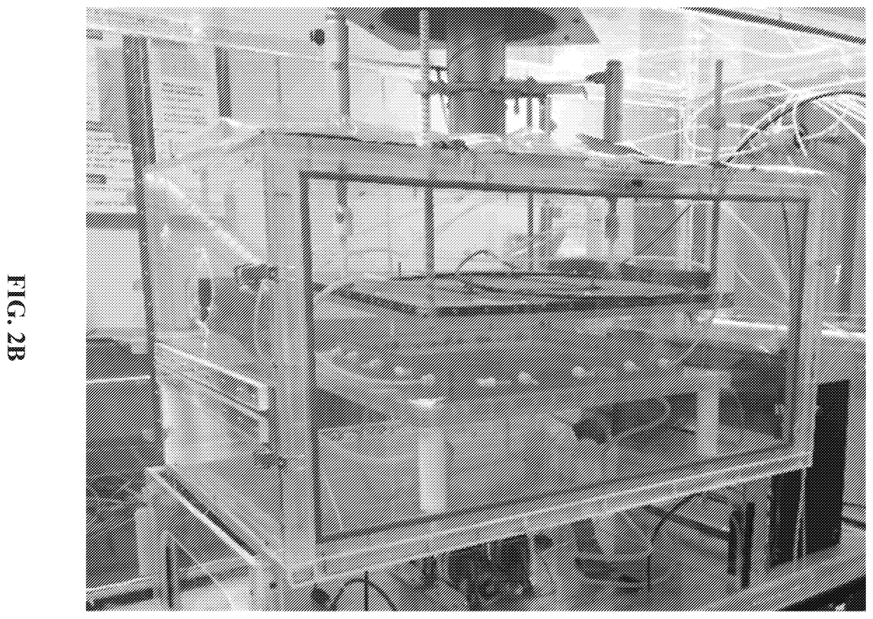

Plasma Treatments: Plasma treatments were performed in either the capacitively-coupled atmospheric plasma unit or the Surfx Atomflo plasma jet system (see FIG. 2).

Acrylic Coating: Prior to any treatment or coating, all CTA films were first cut into appropriate sizes and immersed in a beaker of deionized water. The beaker was placed in an ultrasonic bath to clean the films for a total of 5 minutes. Water was drained and refilled after 1, 2, and 3 minutes to make sure films were fully cleaned. Finally, the CTA films were air dried at room temperature.

First, the cleaned films were placed in the inner chamber of the capacitively coupled atmospheric pressure plasma system. The inner and outer chambers were closed and filled with 20 L/min helium and 0.3 L/min oxygen gas. A voltage of 7.9 kV (plasma system voltage ranges tested from 6.6 kV to 7.9 kV) was applied on the two electrodes of the inner chamber to generate plasma. The films were exposed to plasma for 30 seconds with a frequency of 5 kHz.

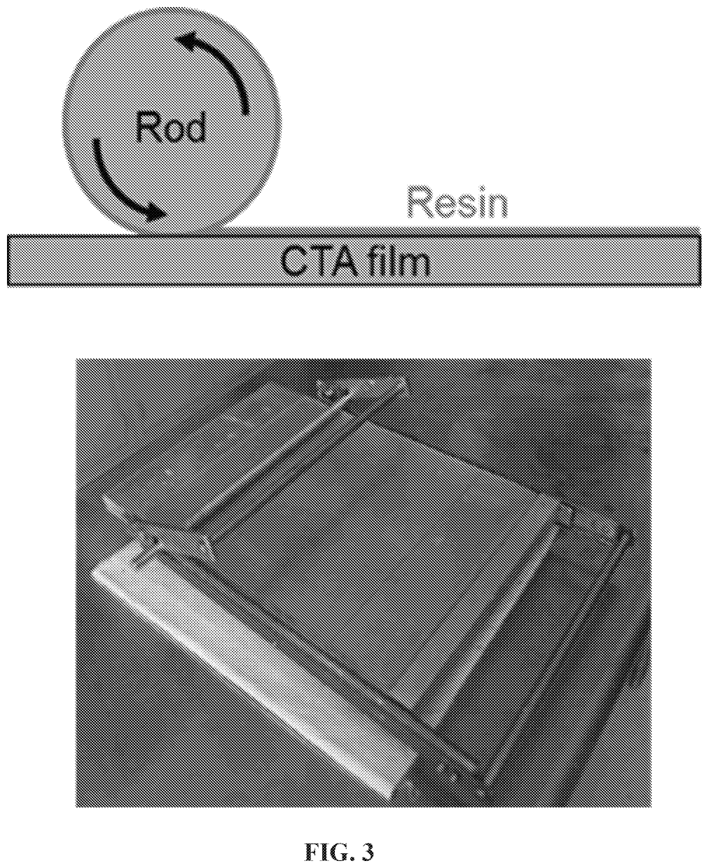

The cleaned films to be coated were placed on a rod coater plate and taped in place as shown in FIG. 3. Approximately 5.0 mL of resin was added across the top of the film. Then, the resin was carefully spread by a smooth glass rod to maintain the uniformity of the coating.

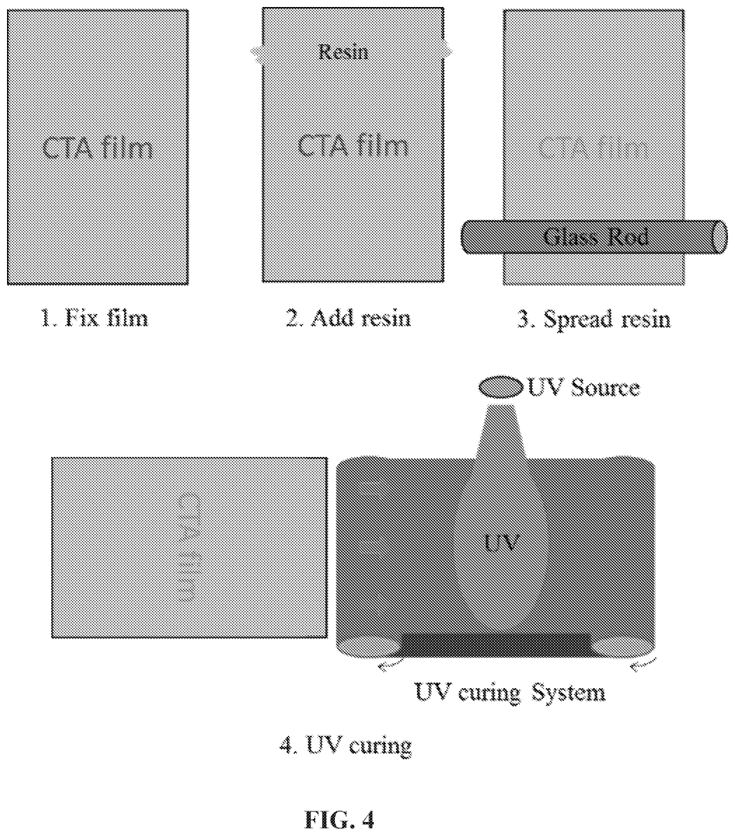

Immediately after the resin application, acrylic coated film was exposed to 385 nm UV light for a total of 15 seconds to avoid film distortion due to heat as shown in FIG. 4. Approximately three sheets were made for each variable condition. After the coating was cured, the dry pickup was calculated.

Contact Angle Measurements: The water contact angles of untreated, plasma treated, and acrylic coated. CTA films were measured at room temperature. Liquid drops (5 μL) were deposited on CTA films and the profiles were captured by stereomicroscope and camera. The contact angles of these CTA films were measured via microscope at least 3 times.

Water Vapor Transmission Rate (WVTR): WVTR is a measure of how much water vapor will pass through a material per unit area per unit time. It was measured according to the ASTM E-96 wet cup method. The Vapometer, model 68-3000 (2″ EZ-Cup) from Thwing-Albert Instrument Company, was used to determine the water vapor permeability of CTA films. These cups have a mechanical sealing system using two neoprene gaskets and a Teflon seal. The water cup method assembly measures weight loss due to water vapor from the cup transmitting through the film to the test atmosphere as a function of time. The WVTR is calculated from the steady-state region.

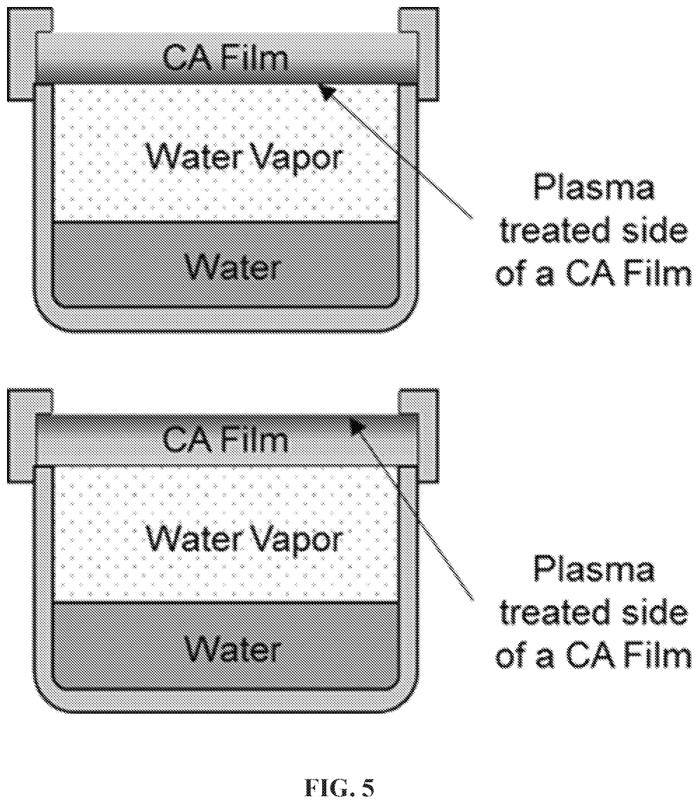

When plasma treatment was performed using the Atomflo, only one side of the film received plasma treatment. In testing WVTR for these films, orientation of the film (plasma treated side facing inside or outside of the cup) was denoted (FIG. 5).

An aluminum cup with a sample film is weighed and placed in a convection oven at 25° C. and 50% RH with an air circulation rate of about 0.5 m·s⁻¹. The sample cup is periodically removed and weighed. The weight loss as a function of time is recorded. The slope of the water loss as a function of time normalized to the testing area (A) is defined as the water vapor transmission rate (WVTR) with units of g d⁻¹·m:⁻²:

$$WVTR = \frac{Water Mass Lost}{Time \times Area} = \frac{Flux}{Area} \qquad ( Equation 1 )$$

The standard deviation of the WVTR is less than 5%. The formula given below represents the relationship between the WVTR and permeability, a material characteristic.

$$Permeability = WVTR ( \frac{l}{Δ P} ) \qquad ( Equation 2 )$$

where l is the film thickness measured using a digital gauge and Δp is the pressure difference across the film. WVTR is sometimes normalized to film thickness (l) to obtain the specific water vapor transmission rate (WVTR×l) with units of (g mil d⁻²·m⁻²). The unit mil is a unit of length equal to one thousandth (10⁻³ of an inch (0.0254 millimeter).

A model as described below was used to predict the WVTR of the coated film based on the film thickness and WVTR of the substrate and the coated materials. According to Fick's laws of diffusion, coating thickness has an inverse proportion to the overall WVTR. of the coated film. Providing that all the partial water vapor permeability or Pᵢ values, of the layers are independent of pressure and concentration and there are no barriers to diffusion due to interfacial phenomena between layers, permeability of a multilayer film obeys the equation:

$$\frac{{L}_{tot}}{{P}_{tot}} = \frac{{L}_{1}}{{P}_{1}} + \frac{{L}_{2}}{{P}_{2}} + \frac{{L}_{3}}{{P}_{3}} … \qquad ( Equation 3 )$$

where L₁, L₂ and L₃ are the thicknesses of layers and P₁, P₂ and P₃ are the corresponding permeabilities. When using specific atmospheric conditions, the partial pressure difference of water vapor between the films surface remains a constant. Thus, the total WVTR of a multilayer structure can be calculated with the help of the WVTRs of all separate layers as follows

$$\frac{1}{{WVTR}_{tot}} = \frac{1}{{WVTR}_{1}} + \frac{1}{{WVTR}_{2}} + \frac{1}{{WVTR}_{3}} … \qquad ( Equation 4 )$$

Note that if equation 4 holds true, the order of the layer structure does not affect the total WVTR value. However, when any Pᵢ is pressure dependent, equation 4 is no longer valid and the use of the model for multilayer estimation may lead to inaccurate results.

Water Absorption: The average amount of absorbed moisture in a material, taken as the ratio of the mass of the moisture in the material to the mass of the dry material and expressed as a percentage, as follows:

$$\% Moisture Absorption = \frac{{W}_{i} - {W}_{0}}{{W}_{0}} \times 100 \qquad ( Equation 5 )$$

where: Wᵢ=current film mass (g), W₀=dry film mass (g)

The saturated moisture absorption was measured for CTA films with a series of areas. These films were immersed in water for 24 hours and dried with air flow. The weight before immersion and after drying was obtained.

Surface Chemistry: The chemical structures of CTA films were studied by X-ray Photoelectron Spectroscopy (XPS, SPECS System with PHOIBOS 150 Analyzer), also known as Electron Spectroscopy for Chemical Analysis (ESCA). It is a widely-used technique to investigate the chemical composition of surfaces. The sampling area and depth of XPS on a sample is about 1 mm² and 10 nm, respectively.

Time-of-Flight Secondary Ion Mass Spectrometry (ToF-SIMS, IONTOF TOF.SIMS⁵) was used to study the etching thickness on the surface of treated films. ToF-SIMS is a highly sensitive surface analytical technique, using a pulsed and focused ion beam (Cs+) and Time-of-Flight analyzer to produce positive and negative mass spectra and images from the outer 1 to 2 nm of the material surface.

Sequential sputtering of surfaces by ion beam of ToF-SIMS allows analysis of the chemical stratigraphy on material surfaces (typical sputtering rates are about 1˜1.2 nm/s).

Surface Roughness: Surface roughness of plasma treated CTA films was determined using an Atomic Force Microscope (AFM, Bruker Dimension 3000). Surface imaging was carried out in tapping mode under ambient conditions (25° C., 30% RH).

Crystallinity: Plasma treated CTA films were analyzed using differential scanning calorimetry (DSC). Percent crystallinity was calculated as follows:

$$\% crystallinity = \frac{Δ {H}_{m} - Δ {H}_{c}}{Δ {H}_{m}^{0}} \times 100 \% \qquad ( Equation 6 )$$

Dimensional Stability: Four CTA films were cut into 4×4 inch squares and dried at 80° C. for 1 hour. Then, the total thickness of the four stacked CTA films were measured to obtain the average thickness of a CTA film, The total thickness was measured at 3 different locations of the stacked CTA films. Next, the stacks of film were immersed in deionized water. After a series of times including intervals of 20, 40, 60, 80, 100, 120, 140, 160, 180, 240, 300, or 360 minutes, the four CTA films were dried with air flow and blotted with a clean paper towel. The thicknesses of the four stacked films were measured to increase the accuracy of the measurement. Measurements were taken 3 times at different locations on the stacked films.

Optical retardation and birefringence: The optical retardation and birefringence of CTA films were measured at three wavelengths including 450. 550, and 650 nm at Eastman. The corresponding color of 450, 550, and 650 nm wavelengths are blue, yellow and red, respectively.

$$\begin{matrix}{R}_{e} = ( {n}_{x} - {n}_{y} ) \times d & ( Equation 7 ) \\ {R}_{th} = ( \frac{{n}_{x} + {n}_{y }}{2} - {n}_{z} ) \times d & ( Equation 8 )\end{matrix}$$

where d is the film thickness and nx, ny, and nz represent the refractive index along the three principal axes x, y and z, respectively. The direction x and y define two mutually orthogonal axes in the film plane, and z is along the film thickness direction.

Analysis of Acrylic Coated CTA Films: Samples obtained from the above processes were tested for WVTR, moisture absorption, optical, and mechanical properties. WVTR was measured according to the ASTM E-96 wet cup method. Moisture absorption: Moisture uptake testing was done using the following steps: (1) modify a film, (2) accurately measure the film weight, (3) equilibrate the film at 90% RH and 23° C. for 24 hours, (4) re-measure film weight. Percent moisture uptake was reported as the final weight minus the original weight, divided by the original weight, multiplied by 100. Optical properties: Light transmittance testing was performed at EMT. Control and plasma treated samples (10 replicate of 2″×2″ size) were prepared and shipped to EMT. Dimensional Stability: Dimensional stability testing was done using the following steps: (1) modify a film, (2) accurately measure the film dimensions, (3) equilibrate the film at 50% RH and 23° C. for 24 hours, (4) re-measure film dimensions. Percent linear change was reported as the final length, minus the original length, divided by the original length, multiplied by 100.

### Example 1—Plasma Treatment of Cellulose Ester Films

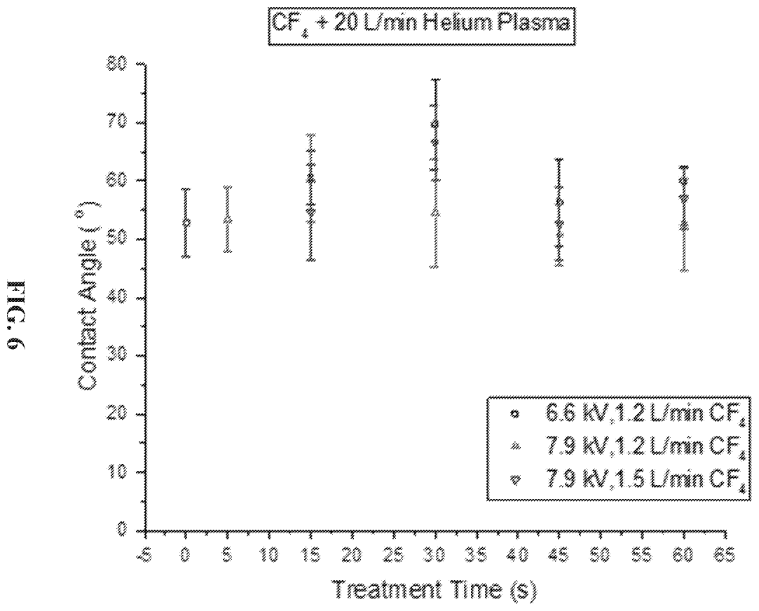

Early tests showed that treatment in some atmospheric plasmas increased the contact angle for CTA films, making surfaces less wettable (see FIG. 6).

Effects of atmospheric plasma treatment on wettability were dependent on the plasma composition and duration of treatment. Increases in contact angle were not correlated with decreases in WVTR.

TABLE 1
Effects of Plasma Treatment on WVTR

| | Contact | | | | |
|---|---|---|---|---|---|
| | Angle | WVTR_1 | WVTR_2 | WVTR 3 | WVTR_{avg} |
| Sample | ° | g/day/m² | g/day/m² | g/day/m² | g/day/m² |
| Untreated | 52.8 ± 5.7 | 268.4 | 268.4 | 293.7 | 276.8 |
| Film | | | | | |
| 20 L/min He, | 49.4 ± 6.1 | 230.4 | 233.8 | 221.0 | 228.4 |
| 6.6 kV, 30 s | | | | | |
| 1.2 L/min | 69.7 ± 7.8 | 236.9 | 233.8 | 224.2 | 231.6 |
| CF₄ + 20 | | | | | |
| L/min He, | | | | | |
| 6.6 kV, 30 s | | | | | |
| 1.2 L/min | 60.0 ± 2.6 | 230.4 | 243.1 | 243.1 | 238.9 |
| CF₄ + 20 | | | | | |
| L/min He, | | | | | |
| 6.6 kV, 60 s | | | | | |
| 2.1 L/min | 57.1 ± 4.7 | 202.1 | 199.0 | 192.7 | 197.9 |
| CF₄ + 20 | | | | | |
| L/min He, | | | | | |
| 7.9 kV, 60 s | | | | | |
| 0.6 L/tnin | 56.5 ± 3.8 | 176.9 | 173.8 | 173.8 | 174.8 |
| C₃F₆ + 20 | | | | | |
| L/min He, | | | | | |
| 7.9 kV, 60 s | | | | | |

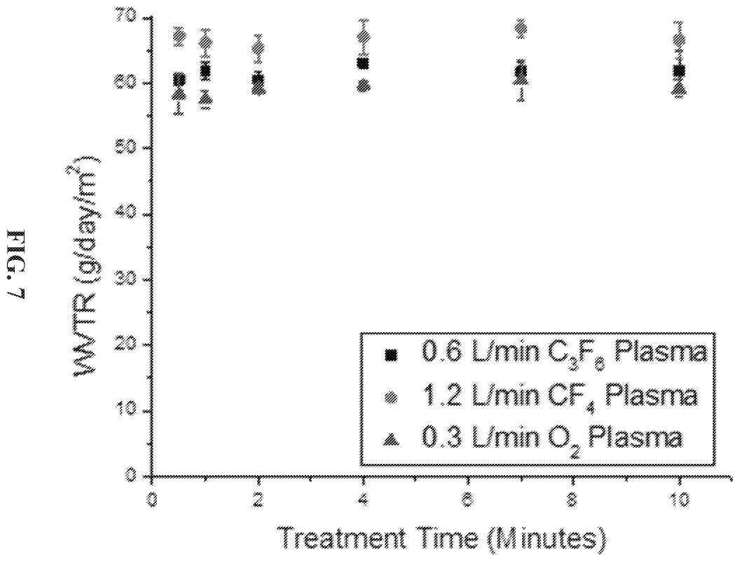

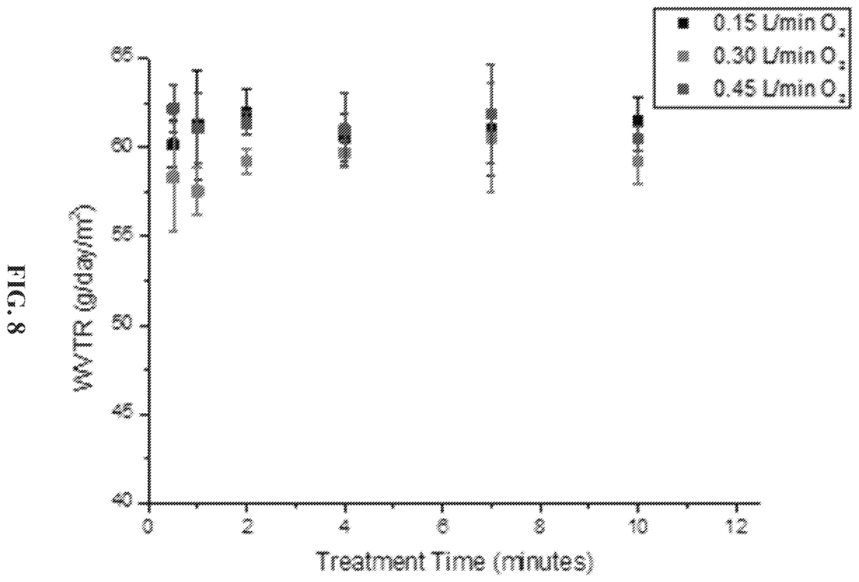

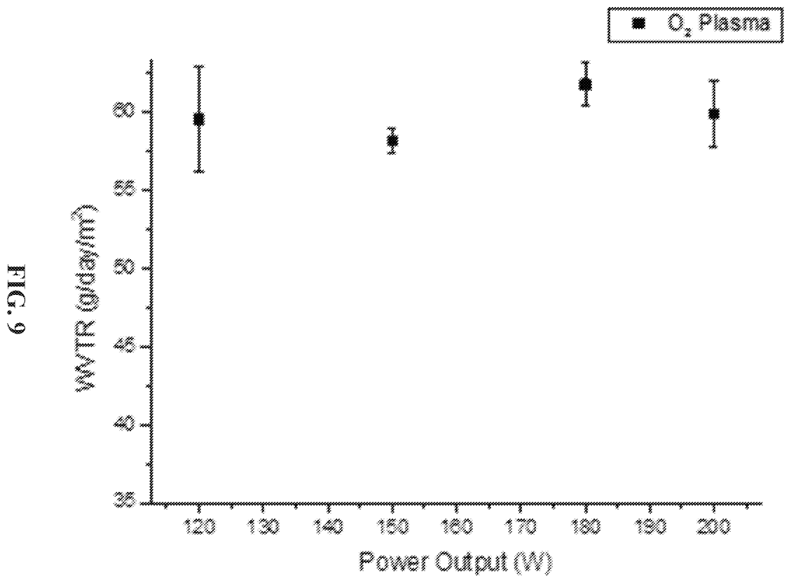

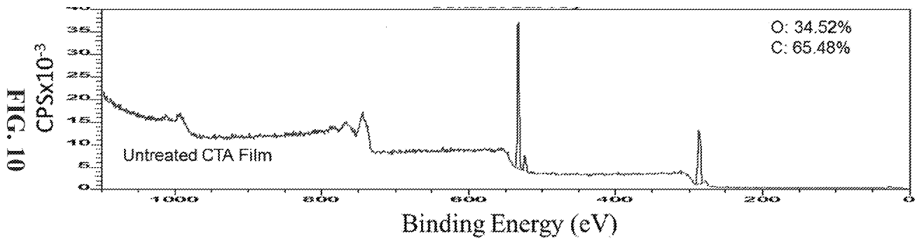

WVTR of plasma treated films was found to depend on the plasma composition and less so on the duration of treatment. Plasma power did not appear to have a significant effect. Characterization of plasma treated films is shown in Table 1 and FIGS. 7-8. The WVTRs of CTA films O₂ plasma treated with the conditions listed in Table 2 are shown in FIG. 9.

TABLE 2
Power outputs and corresponding flow rate of helium and oxygen

| | Power | Helium | Oxygen |
|---|---|---|---|
| | output | flow rate | flow rate |
| | W | L/min | L/min |
| Test 1 | 200 | 30 | 0.9 |
| Test 2 | 180 | 30 | 0.7 |
| Test 3 | 150 | 30 | 0.5 |
| Test 4 | 120 | 30 | 0.3 |

The crystallinity of untreated and plasma treated CTA films are given in Table 3, and indicates that crystallinity increases via plasma treatment.

TABLE 3
Crystallinity of CTA Films

| | Crystallization | Melting | Crystallization |
|---|---|---|---|
| | Heat(J/g) | Heat (J/g) | (%) |
| Untreated CTA Film | 4.6 | 17.2 | 36.6 ± 0.7 |
| O₂ Treated CTA Film | 4.6 | 18.3 | 39.8 ± 0.7 |
| C₃F₆ Treated CTA Film | 4.5 | 18.2 | 39.9 ± 10.8 |

The calculated crystallinity of untreated CTA films is 36.6±0.7%, which increases by about 3% after atmospheric plasma treatment. The crystallinity of O₂ and C₃F₆ plasma treated CTA films indicates that there is no appreciable change with increased treatment time for the O₂ plasma treated samples. The results for the C₃F₆ plasma treatment show a trend of increased crystallinity with increased treatment time up to 60 seconds. When treatment is extended to 120 seconds, the crystallinity drops to its original value (Table 4).

TABLE 4
Crystallinity of CTA Films as a Function of Plasma Treatment Time

| | O₂ Plasma Treated CTA Film | | | C₃F₆ Plasma Treated CTA Film | | |
|---|---|---|---|---|---|---|
| Treatment | Crystallization | Melting | Crystallinity | Crystallization | Melting | Crystallinity |
| Time (s) | Heat (J/g) | Heat (J/g) | (%) | Heat (J/g) | Heat (J/g) | (%) |
| 15 | 4.7 | 18.2 | 39.1 ± 2.0 | 4.8 | 18.6 | 39.5 ± 1.6 |
| 30 | 4.6 | 18.3 | 39.8 ± 0.7 | 4.5 | 18.7 | 39.9 ± 0.8 |
| 60 | 4.6 | 18.2 | 39.4 ± 1.1 | 4.4 | 19.0 | 43.6 ± 1.4 |
| 120 | 4.9 | 18.2 | 38.7 ± 2.9 | 4.7 | 18.6 | 40.3 ± 4.2 |

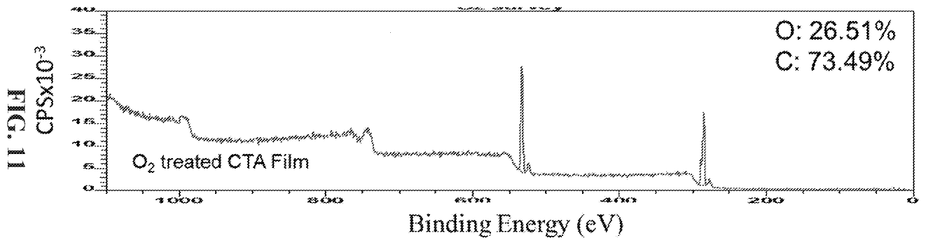

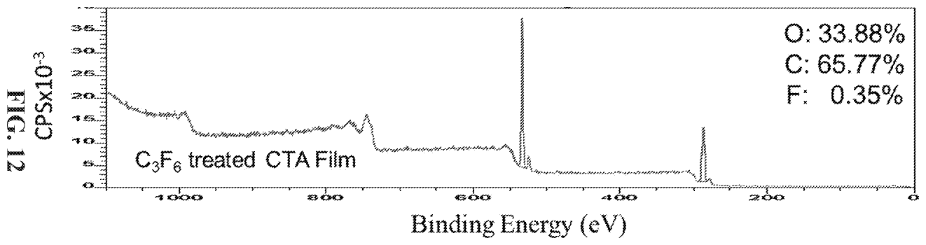

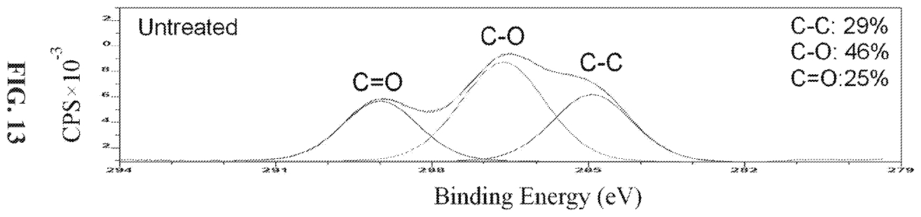

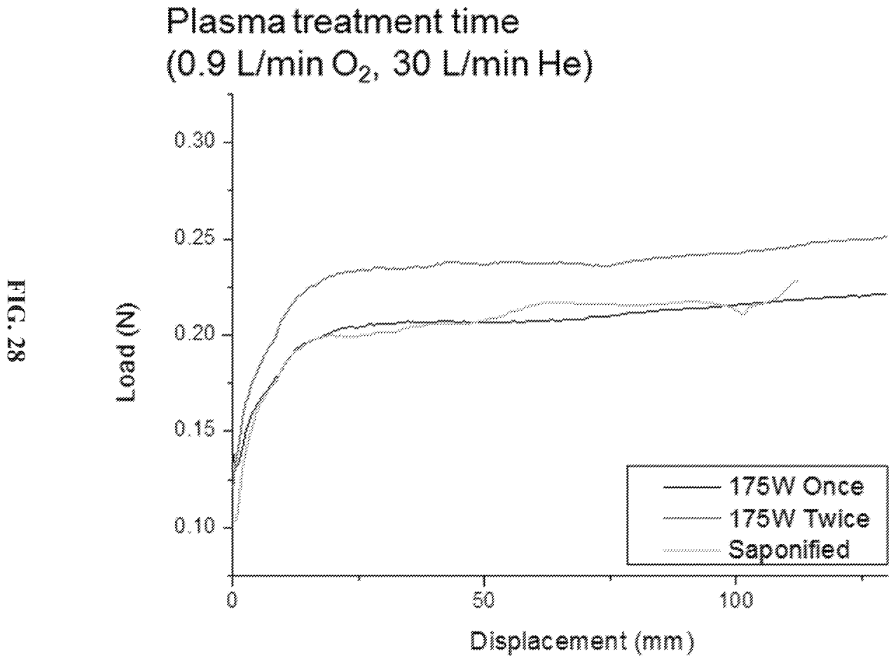

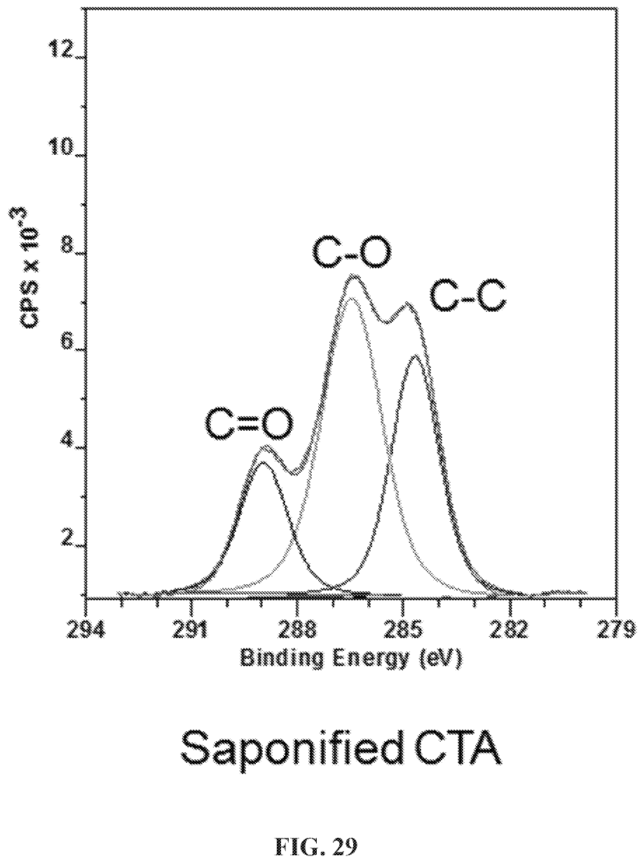

The surface compositions of CTA films were studied by XPS. FIGS. 10-12 show the spectra from the XPS survey of an untreated CTA film (FIG. 10), O₂ plasma treated CTA film (FIG. 11), C₃F₆ plasma treated CTA film (FIG. 12), and saponified CTA film (FIG. 29).

As shown in FIGS. 10-12, the ratio between C and O changes significantly for CTA films with and without O₂ plasma treatment. The amount of oxygen on the surface of a CTA film decreased after O₂ plasma treatment, When C₃F₆ was used for the plasma treatment, a small amount of fluorine was detected on the surface. C₃F₆ plasma had an insignificant effect on the ratio of C and O elements on the surface of treated CTA films.

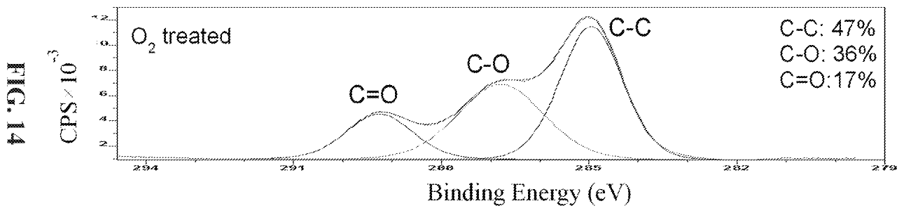

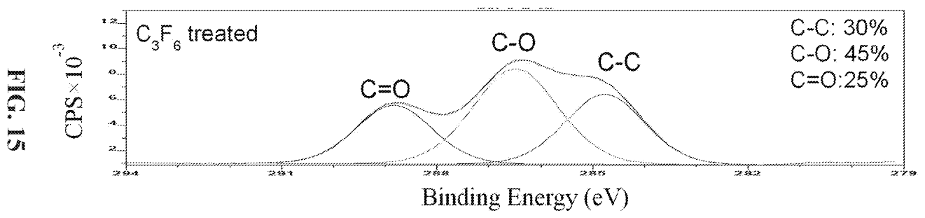

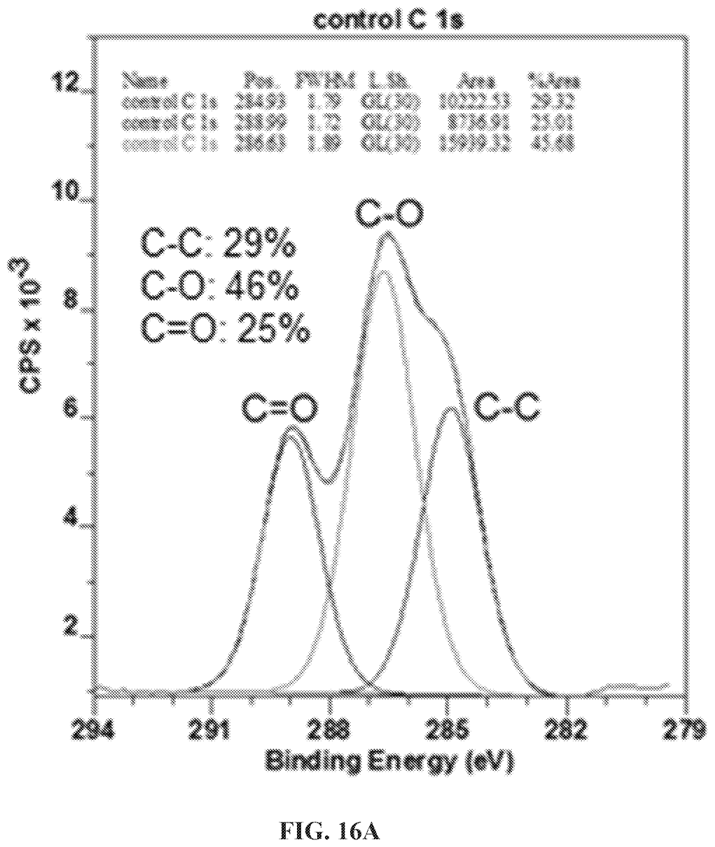

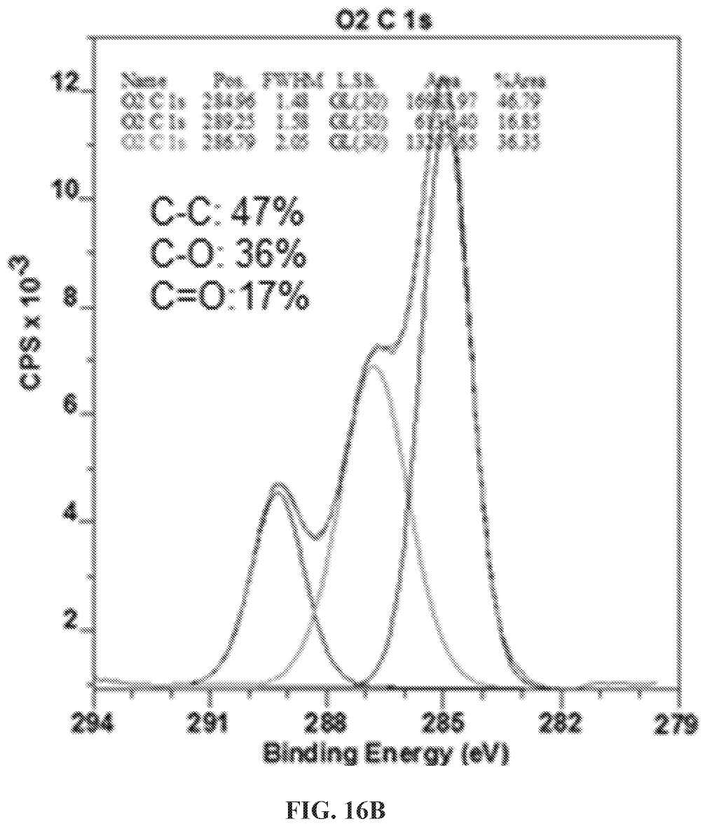

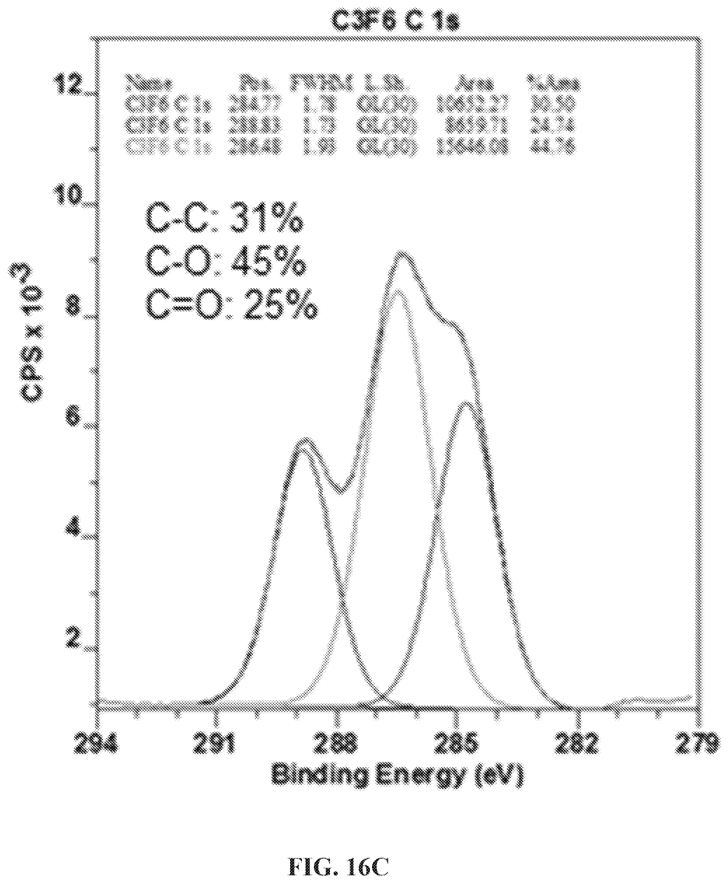

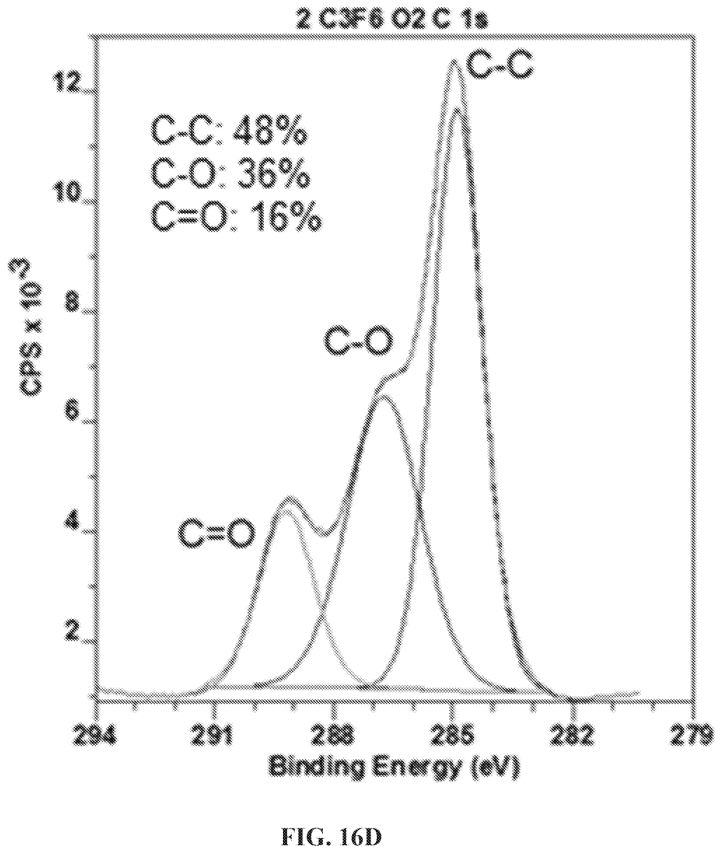

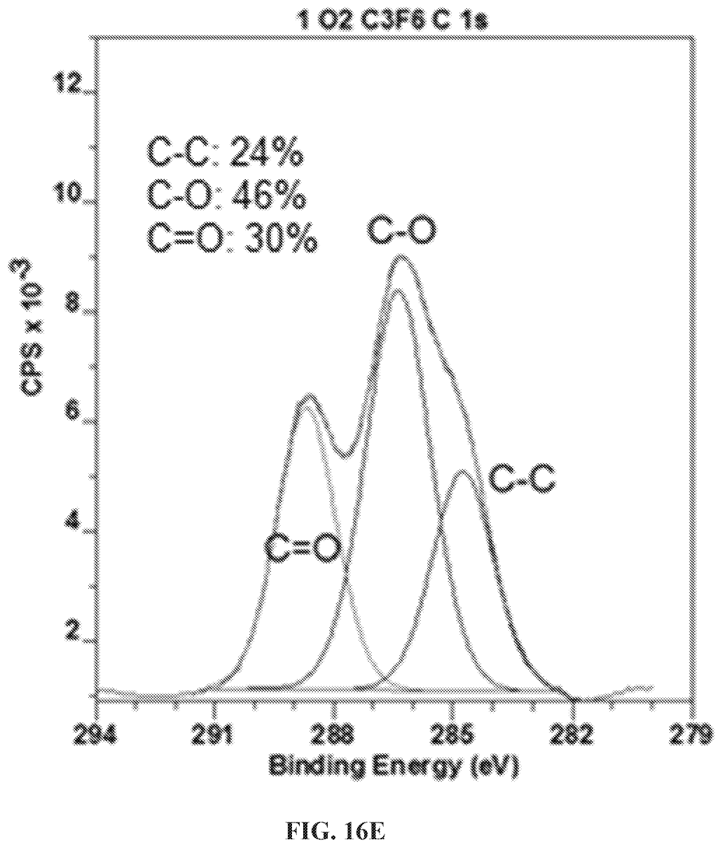

The amount of carbon forming C—C bonds on the surface of a CTA film increased after O₂ plasma treatment, while C₃F₆ plasma treatment had an insignificant effect on the carbon forming C—C bonds of a CTA film. The high-resolution C1s XPS spectra of CTA films with two-step plasma treatments were compared in order to study the difference between the two types of plasma treatment, as illustrated in FIGS. 13-16.

CTA film treated with C₃F₆ plasma and then O₂ plasma possesses similar carbon bonding to CTA film treated with just O₂ plasma. On the other hand, a CTA film treated with O₂ plasma and then treated with C₃F₆ plasma possesses similar carbon bonding to the one treated with just C₃F₆. Therefore, for various plasma treatments, it is the latest type of plasma treatment that determines the chemical bonding on the surface of a plasma treated CTA film.

### Example 2—Plasma Treatment in Combination with Acrylic Coating

WVTR Analysis: Two types of acrylic formulations were prepared for coating on the plasma treated CTA films. These resins were coated on O₂ plasma treated CTA films (4×4, or 6×6 inches) using the rod coating method (FIG. 3 & FIG. 4). The CTA films to be coated were placed on the rod coater plate and taped in place as shown in FIG. 4. Approximately 5.0 mL of resin was added across the top of the film. Then, the resin was carefully spread by a smooth glass rod to maintain the uniformity of the coating.

Formulation 1: Methyl methacrylate monomer (Sigma-Aldrich, 99%, stabilized) was purified to remove the stabilizer (hydroquinone monomethyl ether) by washing with a NaOH solution (2 mol/L). A NaOH solution with the same volume as the MMA monomer was mixed with MMA monomer. The mixture was stirred in an ultrasonic bath for 5 minutes, and then transferred into a separation funnel. The mixture was left to rest in a separation funnel until the phase layers of the NaOH solution and MMA monomer were clearly separated. By separating the two phases with a separation funnel, the stabilizer in the purchased MMA monomer was removed. Diphenyl(2,4,6-trimethylbenzoyl)phosphine oxide (TPO) was used as the photo-initiator of the PMMA resin. 0.1 g of TPO was dissolved in 10 mL of MMA monomer to form PMMA resin. The resin was pre-polymerized using a UVP Longwave Ultraviolet Crosslinker for 1 minute prior to coating. The wavelength and intensity of the UV radiation was 365 nm and 0.2 J/cm², respectively. Then, the pre-polymerized PMMA resin (5.0 mL) was added across the top of an O₂ plasma treated film. Then, the resin was carefully spread by a smooth glass rod to maintain the uniformity of the coating. The coated CTA film was UV cured immediately after coating with 0.2 J/cm² and 365 nm UV radiation for 4 minutes.

Formulation 2: A UV curable acrylic including methyl methacrylate monomer, diphenyl (2,4,6-trimethylbenzoyl) phosphine oxide (TPO) photo-initiator and diacrylate crosslinker obtained from Colorado Photopolymer Solutions (CPS) was coated on the O₂ plasma treated CTA films using the rod coating method. Approximately 5.0 mL of Plastibond 30A resin was added across the top of the film and carefully spread by a smooth glass rod to maintain the uniformity of the coating. The coated film was immediately cured using 0.2 J/cm² and 365 nm UV radiation for 4 minutes.

Also, a single acrylic coated sample was treated in O₂ plasma for 30 seconds after UV curing to assess the effects of plasma treatment on the WVTR of coated samples. The WVTRs of O₂ plasma treated acrylic coated CTA films are listed in Table 5.

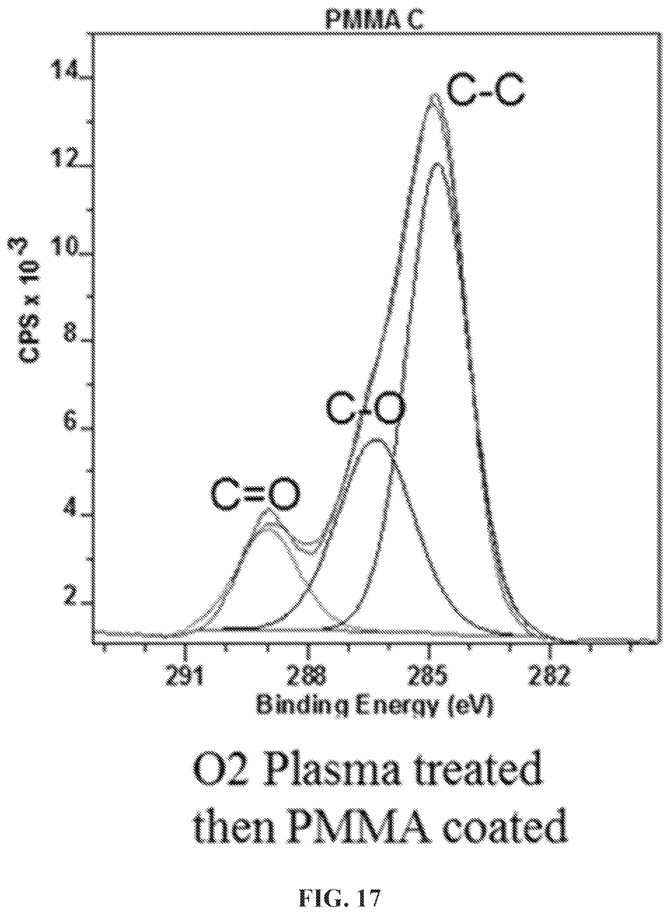

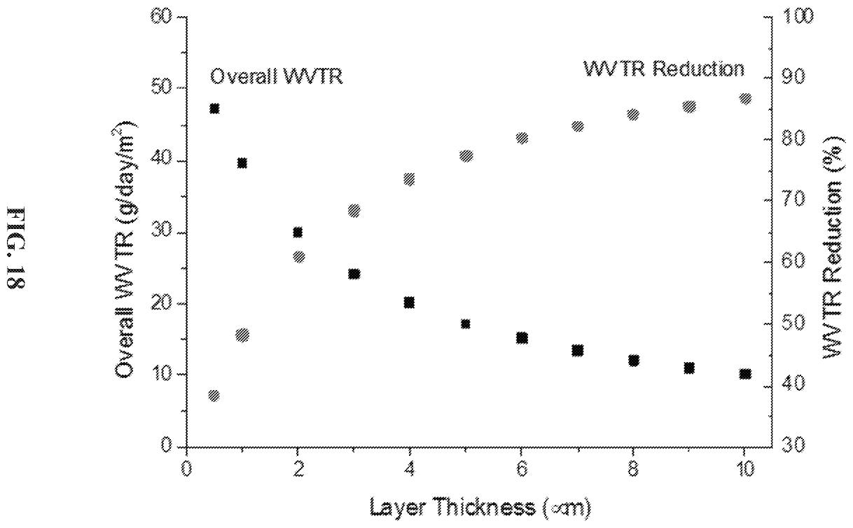

The untreated, O₂ plasma treated, and acrylic coated CTA films were analyzed using XPS. FIG. 17 shows the spectra of untreated, O₂ plasma treated and acrylic (Formulation 2) coated CTA films. After being exposed to O₂ plasma or coating with acrylic resin, the number of C—C bonds increased. For the acrylic coated film, this is because the acrylic coating included more C—C bonds than CTA film.

TABLE 5
WVTR of Plasma Treated and Acrylic Coated CTA films

| | WVTR | | |
|---|---|---|---|
| | WVTR | | Contact |
| | (g/day/m²) | Thickness | Angle |
| Sample | RH 50% | (μm) | (°) |
| Untreated CTA | 71.41 ± 3.35 | 79.00 | 52.8 ± 5.7 |
| O₂ plasma treated CTA | 58.34 ± 3.02 | 79.00 | 38.1 ± 6.1 |
| Acrylic (Formulation 2) coated | 7.78 ± 0.53 | 95 ± 2 | 71.3 ± 3.4 |
| CTA (double-side) | | | |
| Acrylic (Formulation 2) coated | 8.42 ± 0.46 | 87 ± 3 | 68.4 ± 2.2 |
| CTA (one-side) | | | |
| Acrylic (Formulation 2) coated | 8.21 ± 0.73 | 91 ± 2 | 59.6 ± 3.1 |
| CTA (double-side) + O₂ Plasma | | | |
| Acrylic (Formulation 2) sprayed | 51.62 ± 0.82 | 89 ± 2 | 84.3 ± 6.1 |
| CTA (double-side) | | | |
| Acrylic (Formulation 2) sprayed | 62.35 ± 0.79 | 83 ± 2 | 85.3 ± 4.0 |
| CTA (one-side) | | | |
| Acrylic (Formulation 2) coated | 20.63 ± 3.12 | 87 ± 2 | 72.2 ± 3.1 |
| CTA (double-side) | | | |
| Acrylic (Formulation 1) coated | 28.21 ± 1.86 | 82 ± 2 | 73.5 ± 2.6 |
| CTA (one-side) | | | |
| Acrylic (Formulation 1) coated | 35.26 ± 1.64 | 81 ± 2 | 70.4 ± 5.2 |
| CTA (one-side) | | | |
| Acrylic (Formulation 1) coated | 49.78 ± 2.32 | 80 ± 1 | 69.8 ± 4.1 |
| CTA (one-side) | | | |

The density of untreated CTA films and the coating gsm of acrylic coated CTA films were measured and tabulated in Table 6. Nine CTA films with 6×6 inches in size were prepared. The thickness and the weight of all untreated CTA films were measured prior to acrylic coating. The CTA films were acrylic coated in two sets (Formulation 1 and 2) based on the rod coating method. The thickness and weight of the acrylic coated CTA films were measured when the acrylic resin was completely cured. The thickness was measured three times on a film at different locations.

TABLE 6
Thickness, density, and gsm of CTA films

| | Overall | CTA | Coating | Coating |
|---|---|---|---|---|
| | Thickness | density | density | gsm |
| | μm | g/cm³ | g/cm³ | g/m² |
| Untreated CTA | 80.8 ± 1.3 | 1.30 ± 0.15 | 0 | 0 |
| Acrylic (Formulation 1) | 84.7 ± 2.3 | 1.30 ± 0.15 | 1.07 ± 0.06 | 4.65 ± 1.95 |
| coated CTA | | | | |
| Acrylic (Formulation 2) | 86.3 ± 1.5 | 1.30 ± 0.15 | 1.09 ± 0.01 | 5.60 ± 1.93 |
| coated CTA | | | | |

According to Table 6, the thickness of the acrylic coating is between 3 μm to 8 μm. Approximately, 5 g/m² acrylic coating was applied to the CTA film with 4 μm coating thickness.

Acrylic coatings are effective in reducing the WVTR of CTA films. The maximum reduction of WVTR due to acrylic coating was 89%. It was also found that films with both sides coated had better barrier properties to moisture. Due to the non-uniformity of acrylic coating, CTA films coated with sprayed acrylic (Formulation 2) resin had significantly higher WVTRs than those produced with rod coating. The acrylic (Formulation 2) resins have better barrier performance than the acrylic (Formulation I) resin. One possible explanation is that additives and the crosslinker of the acrylic (Formulation 2) resin can also reduce the WVTR.

The validity of Lahinten's equation to describe the WVTR of the composite plasma treated and coated films was verified experimentally using a plasma treated CTA film coated with acrylic (Formulation 2) resin. The WVTR and the thickness of an untreated CTA film, a film made of acrylic resin, and a plasma treated CIA film coated with acrylic resin were measured. For the plasma treated CTA film coated with acrylic resin, the thicknesses before and after coating were measured, so the thickness of the coated acrylic layer (8 μm) was obtained. The predicted and measured WVTR and thicknesses were shown in Table 7.

TABLE 7
Predicted and Measured WVTR and Thicknesses

| | | Measured | Predicted |
|---|---|---|---|
| | Thickness | WVTR | WVTR |
| | μm | g/day/m² | g/day/m² |
| Plasma treated CTA | 75 | 58.3 | N/A |
| Acrylic | 8 | 15.4 | N/A |
| CTA + Acrylic | 83 | 12.2 | 9.4 |

According to this data, Lahtinen's model predicts the WTVR of CTA films coated with an acrylic layer reasonably well. Based on Lahtinen's model, the overall WVTRs as a function of layer thickness were predicted in FIG. 18. According to FIG. 18, WVTR reduces as the layer thickness increases. In order to achieve a 90% reduction of WVTR, the thickness of the layer should be at least 10 μm.

CTA films treated with O₂ plasma and acrylic (Formulation 2) coating were submitted to Eastman for a light transmittance test.

Dimensional Stability Analysis: Four CTA films were cut into 4×4 inch squares and dried at 80° C. for 1 hour. Then, the total thickness of the four stacked CTA films were measured to obtain the average thickness of a CTA film. The total thickness was measured at 3 different locations of the stacked CTA films. Next, the stacks of film were immersed in deionized water. After a series of time including 20, 40. 60, 80, 100, 120, 140, 160, 180, 240, 300, or 360 minute intervals, the four CTA films were dried with air flow and blotted with a clean paper towel. The thicknesses of the four stacked films were measured to increase the accuracy of the measurement. Measurements were taken 3 times at different locations on the stacked films.

FIG. 19 indicates that the CTA films with acrylic (Formulation 2) coating have improved dimensional stability when compared with untreated CTA films subjected to water immersion.

Optical Analysis: Optical retardation and birefringence of CTA films were measured at three wavelengths including 450, 550, and 650 nm at Eastman. The corresponding colors of 450, 550, and 650 nm wavelength are blue, yellow and red, respectively. The in-plane retardation (Rₑ) and thickness direction retardation (Rₜₕ) are defined as described above in Equations 7 & 8.

According to Table 8, birefringence and optical retardation of untreated, O₂ plasma treated and acrylic (Formulation 2) treated CTA films are close in the ratio of Rₑ and Rₜₕ values at 450/550 and 650/550 wavelengths.

TABLE 8
Light Transmittance of CTA films

| | Rₑ (nm) | Rₜₕ (nm) | Rₑ 450/550 | Rₑ 650/550 |
|---|---|---|---|---|
| Untreated | 0.989 ± 0.069 | −38.882 ± 2.113 | 0.597 ± 0.076 | 1.259 ± 0.105 |
| One-side | 1.051 ± 0.100 | −46.114 ± 2.143 | 0.677 ± 0.041 | 1.273 ± 0.090 |
| acrylic- | | | | |
| treated | | | | |
| Two-side | 1.024 ± 0.130 | −48.106 ± 1.221 | 0.601 ± 0.064 | 1.217 ± 0.079 |
| acrylic- | | | | |
| treated | | | | |
| Plasma- | 1.013 ± 0.086 | −40.336 ± 1.054 | 0.618 ± 0.073 | 1.254 ± 0.056 |
| treated | | | | |
| | Rₜₕ 450/550 | Rₜₕ 650/550 | b* | haze % |
| Untreated | 0.873 ± 0.007 | 1.110 ± 0.006 | 0.188 ± 0.008 | 0.831 ± 0.163 |
| One-side | 0.878 ± 0.007 | 1.016 ± 0.285 | 0.795 ± 0.086 | 1.215 ± 0.433 |
| acrylic- | | | | |
| treated | | | | |
| Two-side | 0.875 ± 0.006 | 1.103 ± 0.004 | 1.073 ± 0.123 | 1.216 ± 0.591 |
| acrylic- | | | | |
| treated | | | | |
| Plasma- | 0.875 ± 0.005 | 1.106 ± 0.003 | 0.387 ± 0.007 | 0.748 ± 1.320 |
| treated | | | | |

### Example 3—Characterization of CTA Films and Acrylic Coatings

Materials & Methods

Materials: CTA films were provided by Eastman Chemical Company. The helium and oxygen gases utilized in the atmospheric plasma systems as working and reactive gasses were procured from Airgas. Methyl methacrylate monomer (99%, stabilized) and diphenyl (2,4,6-trimethylbenzoyl) phosphine oxide (TPO) photo-initiator were obtained from Sigma-Aldrich. In addition to TPO, 2-Hydroxy-2-methylpropiophenone (1173) and 1-Hydroxycyclohexyl phenyl ketone (184) purchased from Sigma-Aldrich were used as initiators for acrylic polymerization.

UV curable acrylic resins were obtained from Colorado Photopolymer Solutions (CPS) including plastibond 30A, CPS 1025A, and CPS 1030. Acetone (analytical grate Sigma-Aldrich) was used for diluting resins for ultrathin coating. In addition to methyl methacrylate, multi-functional acrylates were used as monomer or mixed with methyl methacrylate to increase crosslinking of the acrylic coating. The multi-functional acrylates include di(ethylene glycol) dimethacrylate (95%, Sigma-Aldrich), triethylene glycol dimethacrylate (95%, Sigma-Aldrich), pentaerythritol triacrylate (technical grade, Sigma-Aldrich), Trimethylolpropane triacrylate (technical grade, Sigma-Aldrich), and Pentaerythritol tetraacrylate (technical grade, Sigma-Aldrich). Acronal S 504, an acrylic latex resin, was supplied by BASF.

PVA film (551 Sol-U-Film) procured from Pollen for lamination and adhesion tests with CTA films. Commercially available PVA-iodine polarizer films (PF006) were purchased for lamination and adhesion tests with CTA films.

Washing: Before any treatment or coating, all CTA films were cut into appropriate sizes and immersed in a beaker of deionized water. The beaker was placed in an ultrasonic bath to clean the films for a total of 5 minutes. Water was drained and refilled after 1, 2, and 3 minutes to make sure films were thoroughly cleaned. Finally, the CTA films were air dried at room temperature.

Plasma treatment: The cleaned films were placed in the inner chamber of the capacitively coupled atmospheric pressure plasma system. The inner and outer chambers were closed and filled with 20 L/min helium and 0.3 L/min oxygen gas. A voltage of 7.9 kV (plasma system voltage ranges tested from 6.6 kV to 7.9 kV) was applied to the two electrodes of the inner chamber to generate plasma. Films were exposed to the plasma for 30 seconds. The frequency of the plasma was 5 kHz.

In addition to the capacitively coupled atmospheric pressure plasma system, atmospheric plasma treatment of CTA films was also conducted using the Atomflo™ 500 plasma jet system with a linear plasma head. Compared with the custom-made capacitively coupled atmospheric pressure plasma system, the Atomflo™ 500 plasma jet system can be utilized for single plasma treatment with a calibrated power output and different flow rates of helium and oxygen. The linear plasma head was mounted on a benchtop robot. The benchtop robot was pre-programmed to achieve various exposure times.

The scan speed of the linear plasma head on the bench was set to 1.0 cm/s. CTA films were attached to the bench plate, and then plasma treated under a series of power outputs with the system default flow rate of helium (30 L/min) and oxygen (0.3 L/min). The linear plasma head scanned the entire bench fixed with a CTA film, so the side facing up was modified. The power outputs and corresponding default flow rate of helium and oxygen are listed in Table 9.

TABLE 9
Plasma Treatment Parameters

| | Power output | Helium flow rate | Oxygen flow rate |
|---|---|---|---|
| | W | L/min | L/min |
| Test 1 | 200 | 30 | 0.9 |
| Test 2 | 180 | 30 | 0.7 |
| Test 3 | 150 | 30 | 0.5 |
| Test 4 | 120 | 30 | 0.3 |

Coating application: Before coating, the cleaned CTA films were treated by O₂ plasma (150 W, 30 L/min helium, 0.5 L/min oxygen) for 30 seconds to increase their adhesion with acrylic coating.

Two types of acrylic formulations were prepared for coating on the plasma treated CTA films. These resins were coated on O₂ plasma treated CTA films using the rod coating method. Rod coating was utilized to coat the resin on the surface of a plasma treated CTA film. The CTA films to be coated were placed on a rod coater plate and taped in place. Approximately 5.0 mL resin was added across the top of the film. Then, the resin was carefully spread by a smooth glass rod to maintain the uniformity of the coating.

Formulation 1: methyl methacrylate monomer (Sigma-Aldrich, 99%, stabilized) was purified to remove the stabilizer (hydroquinone monomethyl ether) by washing with a NaOH solution (2 moll). A NaOH solution with the same volume as the MMA monomer was mixed with MMA monomer. Multi-functional acrylates were used as monomer or mixed with methyl methacrylate to increase crosslinking of the acrylic coating. The multi-functional acrylates include di(ethylene glycol) dimethacrylate (95%, Sigma-Aldrich), triethylene glycol dimethacrylate (95%, Sigma-Aldrich), pentaerythritol triacrylate (technical grade, Sigma-Aldrich), Trimethylolpropane triacrylate (technical grade, Sigma-Aldrich), and Pentaerythritol tetraacrylate (technical grade, Sigma-Aldrich). The mixture was stirred in an ultrasonic bath for 5 minutes and then transferred into a separation funnel. The mixture was left to rest in a separation funnel until the phase layers of the NaOH solution, and MMA monomer was separated, By separating the two phases with a separation funnel, the stabilizer in the purchased MMA monomer was removed. Diphenyl(2,4,6-trimethylbenzoyl)phosphine oxide (TPO) was used as the photo-initiator of the PMMA resin. 0.1 g TPO was dissolved in 10 mL of MMA monomer to form PMMA resin. The resin was pre-polymerized using a LAP Longwave Ultraviolet Crosslinker for 1 minute before coating. The wavelength and intensity of the UV radiation were 365 nm and 0.2 J/cm², respectively. Then, the pre-polymerized resin of PMMA (5.0 mL) was added across the top of an O₂ plasma treated film to be coated. Then, the resin was carefully spread by a smooth glass rod to maintain the uniformity of the coating. The coated CTA film was UV cured immediately after coating with 0.2 J/cm² and 365 nm UV radiation for 4 minutes.

Formulation 2: a UV curable acrylic including methyl methacrylate monomer, diphenyl (2,4,6-trimethylbenzoyl) phosphine oxide (TPU) photo-initiator and diacrylate crosslinker obtained from Colorado Photopolymer Solutions (CPS) was coated on the O₂ plasma treated CTA films using the rod coating method. Approximately 5.0 mL of Plastibond 30A resin was added across the top of the film and carefully spread by a smooth glass rod to maintain the uniformity of the coating. The coated film was immediately cured using 0.2 J/cm²and 365 nm UV radiation for 4 minutes.

UV curing: Immediately after the resin application, acrylic coated film was cured using 385 nm UV light for a total of 15 seconds to avoid film distortion due to heat. Three sheets were made for each variable condition. After curing, the dry pickup was calculated.

Pre-polymerization: To avoid evaporation of the resin while coating and to control polymerization shrinkage, MMA based resins were pre-polymerized before coating on CTA films. First, resins were prepared and then exposed to 365 nm UV light (0.10 J/cm²) to reach about 10-20% conversion (viscosity as an indicator) using UVP longwave Ultraviolet Crosslinker. Then, the pre-polymerized resin was coated on CTA films. Finally, the coated CTA films were cured with UV radiation (ultrasonic UV source, 280 nm) as described in the UV curing section.

Water vapor transmission: Water vapor transmission rate (WVTR) was measured by the water cup method according to the ASTM E96 (Standard Test Methods for Water Vapor Transmission of Materials) & ISO 12572 (Hygrothermal performance of building materials and products-Determination of water vapor transmission properties) method. The cup was purchased from Thwing-Albert Instrument Company and can test samples up to 3 mm (⅛ in.) thickness. The diameter, depth, and weight of the aluminum cup are 63.5 mm (2.5 in.), 50.8 mm (2.0 in.), and 153.4 grams, respectively. WVTR measurements were conducted at 50% RH and 23° C.

T-peel test: The adhesion between CTA and PVA was measured using the T-peel test that follows the ASTM D1876—Standard Test Method for Peel Resistance of Adhesives (T-Peel Test). The size of the prepared test panels was 152 mm (6 inches) wide by 305 mm (12 inches) long. PVA bonded only over approximately 241 mm (9 inches) of their length in between two CTA films. The bonded panels were cut into 25 mm (1 inch) wide test specimens by a means that was not deleterious to the bond. The 76 mm (3 inches) long unbonded ends were bent apart, perpendicular to the glue line, for clamping in the grips of the testing machine.

According to the ASTM D1876 Standard, test specimens were conditioned for seven days at a relative humidity of 50% at 23° C. The bent, unbonded ends of the test specimen were clamped in the test grips of the tensile testing machine (Instron Model 4443). A load was applied at a constant head speed of 254 mm/min. During the peel test, load versus head movement or load versus distance peeled was recorded for adhesion strength.

PVA Solution Makedown: Polyvinyl Alcohol (PVA) (Mowiol® 56-98, Sigma-Aldrich) powder was slowly dissolved in deionized water in a beaker at room temperature at target solids of 13%. Then, the solution was heated and kept at 90° C. for 30 minutes under mixing. Finally, the solution was cooled to room temperature and used for preparing the films.

Film 1: First PVA solution was spread on a CTA film and then another CTA film was placed on top of PVA solution. The composite (PVA sandwiched between CTA films) specimen was dried in an oven at 80° C. for 30 minutes.

Film 2: PVA solution was spread on a plastic mold and air dried for 24 hours. The dried PVA film was slowly peeled from the mold and placed between two CTA films. Then, they were laminated using a hot press at various temperatures and pressures to determine the optimum condition.

Film 3: Commercially available PVA film (551 Sol-U-Film) placed between two CTA films. Then, they were laminated using a hot press at various temperatures and pressures to determine the optimum condition.

Film 4: Commercially available PVA film doped with iodine placed between two CTA films. Then, they were laminated using a hot press at 120° C. and 25 klb pressure, an optimized condition from lamination of film 3.

90-degree peel test: The adhesion between CTA and pressure sensitive adhesives (PSAs) was measured using the 90-degree peel test according to ASTM D3300 Standard Test Method for Peel Adhesion of Pressure-Sensitive Tape. The size of test tape was 1-inch width and 12 inches length. Before the test, test samples and tapes were conditioned at 23° C. and 50% RH. A series of tests at different peel rates were conducted to find an optimum setting that minimizes noise in the data. The adhesion testing of CTA films with two different PSA tapes (ASTM D3300 Standard PSA and Eastman PSA) were measured using an Instron tensile tester (Model 4443) with an angled fixture (Material Testing Technology Co. Model PSTC.00006.11).

Light Transmittance: The light transmittance of CTA films was measured using the PROBE Spectroscopy System from ANTAS Technology Corp. with 330-850 nm measurement wavelength. Three critical wavelengths, 450 nm, 550 nm, and 650 nm were chosen to estimate the retardation of blue, yellow and red light, respectively.

### Results and Discussion

Testing of crosslinking agents in methyl methacrylate for WVTR reduction: The information of the crosslinking agents is provided in Table 10.

TABLE 10
Crosslinking Agents

| | | Number | |
|---|---|---|---|
| | | of | |
| | | Acryloyl | |
| Name | Abbreviation | Groups | Structure |
| Di(ethylene glycol) dimethacrylate | DEGDA | 2 | 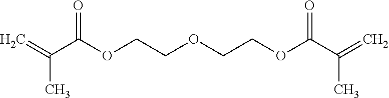 [SMILES: C=C(C)C(=O)OCCOCCOC(=O)C(=C)C] |
| Triethylene glycol dimethacrylate | TEGDA | 2 | 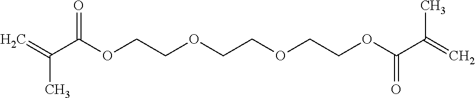 [SMILES: C=C(C)C(=O)OCCOCCOCCOC(=O)C(=C)C] |
| Pentaerythritol triacrylate | PETA | 3 | 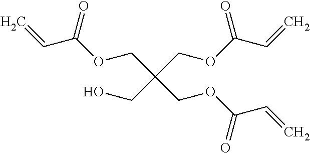 [SMILES: C=CC(=O)OCC(CO)(COC(=O)C=C)COC(=O)C=C] |
| Trimethylolpropane triacrylate | TMPTA | 3 | 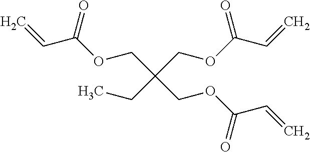 [SMILES: C=CC(=O)OCC(CC)(COC(=O)C=C)COC(=O)C=C] |
| Pentaerythritol tetraacrylate | PETA | 4 | 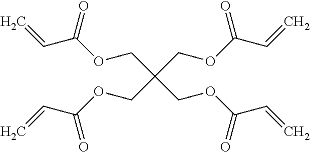 [SMILES: C=CC(=O)OCC(COC(=O)C=C)(COC(=O)C=C)COC(=O)C=C] |

These multi-functional crosslinking agents have more than one acryloyl groups that are capable of causing radical polymerization of acrylic polymer chains forming a crosslinking structure. The crosslinking agents were used as monomer or mixed with MMA monomer with volumetric ratio 1:1. With TPO as an initiator, CTA films were rod coated with the acrylic resins with crosslinking agents. The WVTRs are shown in Table 11.

TABLE 11
WVTR of CTA films

| | WVTR | | |
|---|---|---|---|
| | (g/day/m2), | Thickness | Contact |
| Sample IDs/Treatment Type | RH 50% | (μm) | Angle(°) |
| Control CTA | 71.41 ± 3.35 | 79 ± 2 | 52.8 ± 5.7 |
| Saponified CTA film | 79.24 ± 3.46 | 79 ± 2 | 35.2 + 5.2 |
| O₂ treated CTA | 58.34 ± 3.02 | 79 ± 2 | 38.1 ± 6.1 |
| Acrylic latex (Acronal S 504) | 56.63 ± 0.52 | 85 ± 3 | 70.4 ± 5.2 |
| Formulation 1 (PMMA only) Acrylic | 28.21 ± 1.86 | 82 ± 2 | 73.5 ± 2.6 |
| coated CTA | | | |
| Formulation 1 and TEGDA 1:1 coated | 26.26 | 82 ± 2 | 72.1 ± 3.2 |
| CTA | | | |
| Formulation 1 and TMPTA 1:1 coated | 25.81 | 82 ± 2 | 74.1 ± 2.6 |
| CTA | | | |
| Formulation 1 and PETA 1:1 coated | 23.35 | 82 ± 2 | 71.7 ± 5.4 |
| CTA | | | |
| Formulation 2 Acrylic coated CTA | 7.78 ± 0.53 | 95 ± 2 | 71.3 ± 3.4 |
| Formulation 2 Acrylic coated CTA | 8.42 ± 0.46 | 87 ± 3 | 68.4 ± 2.2 |
| Formulation 2 Acrylic coated CTA | 8.21 ± 0.73 | 91 ± 2 | 59.6 ± 3.1 |
| Formulation 2 Acrylic sprayed CTA | 62.35 ± 0.79 | 83 ± 2 | 85.3 ± 4.0 |
| Formulation 2 Acrylic sprayed CTA | 51.62 ± 0.82 | 89 ± 2 | 84.3 ± 6.1 |

Table 11 shows that the WVTR of the acrylic coating decreased with the addition of crosslinking agents. The WVTR of resin with MMA and crosslinking agents was 23.35 g/day/m² compared to no crosslinking agent was 28.21±1.86 g/day/m². Further, PETA crosslinking agents gave the lowest WVTR. Furthermore, saponified CTA films have higher WVTR than those treated with O₂ plasma and acrylic coated.

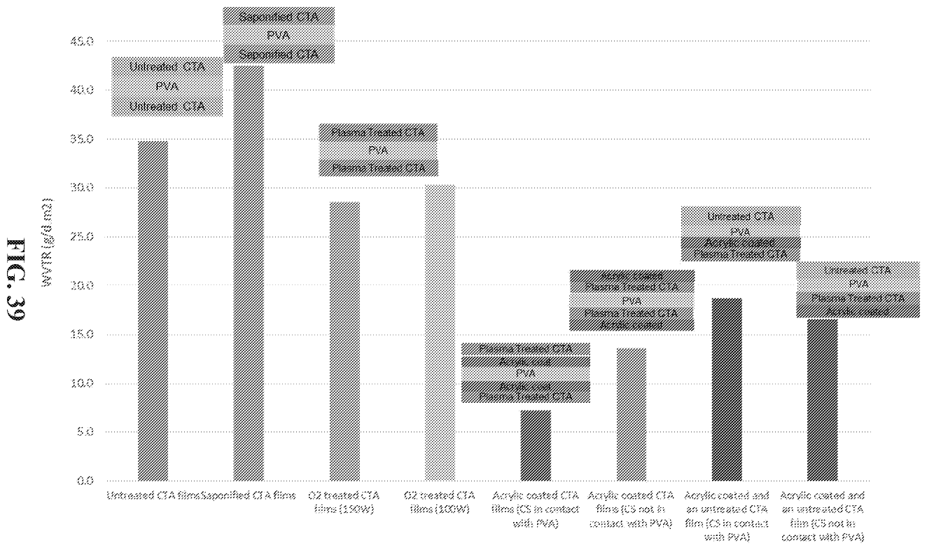

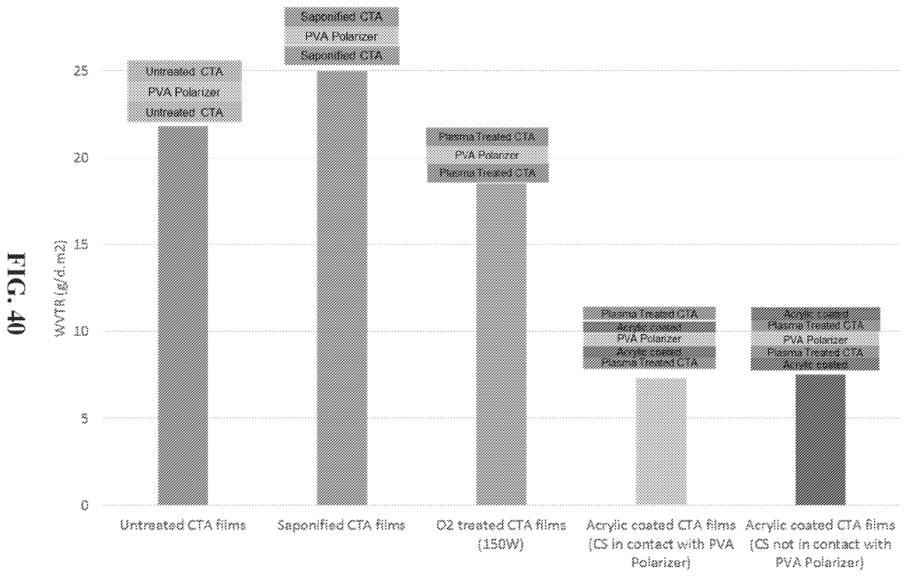

In addition to CTA films with plasma treatment, saponification, and acrylic coatings, the WVTR of PVA films (Pollen 551 Sol-U-Film) sandwiched by two CTA films were measured. As shown in Table 12, FIG. 39 and FIG. 40 the WVTRs of laminated films provides an estimated WVTR where CTA films are used to protect polarizers (treated PVA films).

TABLE 12
WVTR of Pollen 551 Sol-U-Film PVA laminated with two CTA films

| | | Total |
|---|---|---|
| | WVTR | Thickness |
| PVA (551 Sol-U-Film)-CTA Laminated Films | (g/day · m2) | (μm) |
| 1. Untreated CTA films | 34.81 ± 4.45 | 183 ± 5 |
| 2. Saponified CTA films (both sides) | 42.48 ± 3.80 | 184 ± 6 |
| 3. O₂ treated (1) CTA films (150 W, both sides) | 28.50 ± 4.06 | 182 ± 3 |
| 4. O₂ treated (2) CTA films (100 W, both sides) | 30.32 ± 4.23 | 183 ± 3 |
| 5. Acrylic coated (1) CTA films coated side in | 13.22 ± 2.24 | 193 ± 4 |
| contact with PVA) | | |
| 6. Acrylic coated (2) CTA films coated side in | 722 ± 262 | 199 ± 7 |
| contact with PVA) | | |
| 7. Acrylic coated (3) CTA films (coated side | 13.56 ± 3.44 | 199 ± 4 |
| not in contact with PVA) | | |
| 8. Acrylic coated (4) CTA films (coated side | 8.58 ± 4.60 | 204 ± 7 |
| not in contact with PVA) | | |
| 9. Acrylic coated and an untreated CTA film | 18.66 ± 2.16 | 185 ± 4 |
| (coated side in contact with PVA) | | |
| 10. Acrylic coated and an untreated CTA film | 16.54 ± 4.28 | 183 ± 5 |
| (coated side not in contact with PVA) | | |
| 11. Saponified then acrylic coated CTA | 10.51 ± 3.63 | 198 ± 5 |
| films(coated side in contact with PVA) | | |
| 12. Saponified then acrylic coated CTA | 11.82 ± 4.27 | 199 ± 7 |
| films(coated side not in contact with PVA) | | |
| 13. Saponified then acrylic coated and an | | |
| untreated CTA film(coated side in contact with | 21.78 ± 3.75 | 186 ± 4 |
| PVA) | | |
| 14. Saponified then acrylic coated and an | 23.49 ± 3.62 | 185 ± 5 |
| untreated CTA film(coated side in contact with | | |
| PVA) | | |
| 15. Acrylic coated then saponified CTA films | 12.01 ± 2.71 | 199 ± 6 |
| coated side in contact with PVA) | | |
| 16. Acrylic coated then saponified CTA films | 12.40 ± 3.68 | 198 ± 7 |
| (coated side in not contact with PVA) | | |

Table 12 indicates that PVA sandwiched by saponified CTA films has higher WVTR than that of untreated or O₂ plasma treated CTA films. This may be because saponification increases the WVTR of CTA films as shown in Table 11. The WVTR of PVA sandwiched by acrylic coated CTA films showed up to 79% reduction of WVTR compared with PVA sandwiched by untreated CTA films. It should be mentioned that all the acrylic coated CTA films mentioned in Table 12 are one-side acrylic coated. In Table 12, sample 5 and 6 are PVA sandwiched by two CTA films with the acrylic coated side in direct contact with PVA, while sample 7 and 8 are PVA sandwiched by two CTA films with the acrylic coated side not in contact with PVA. Laminated samples with the acrylic coated side, not in direct contact with the PVA film shows slightly higher WV R than those in direct contact with the PVA film. Sample 9 is PVA sandwiched with an untreated CTA film on one side and an acrylic coated CTA film on another side. The acrylic coating was in direct contact with PVA. Sample 10 has the similar construction as sample 9 except acrylic coated CTA film side was not in direct contact with PVA. Sample 10 shows better moisture barrier performance since the acrylic coated side is exposed to higher humidity during the WVTR. measurement. This agrees with the conclusion of one-side surface treatment discussed previously. For samples 11, 12, 13, and 14, saponification causes a slight increase in WVTR of CTA films. For sample 15 and 16, only the acrylic coated side was saponified. PVA sandwiched with acrylic coated CTA film showed lower WVTR when compared to saponified CTA film. There was no significant change observed after laminating the polarizer with untreated, saponified, O₂ plasma treated, and acrylic coated CTA films. The WVTR and total thickness of each laminated samples are listed in Table 13.

TABLE 13
WVTR of PVA-iodine polarizer laminated with two CTA films

| | | Total |
|---|---|---|
| PVA (PVA-iodine polarizer film)-CTA | WVTR | Thickness |
| Laminated Films | (g/day · m2) | (μm) |
| 1. Untreated CTA films | 21.8 ± 3.5 | 295 ± 3 |
| 2. Saponified CTA films (both sides) | 25.1 ± 2.6 | 293 ± 4 |
| 3. O₂ treated CTA films (150 W, both sides) | 18.5 ± 4.2 | 295 ± 3 |
| 4. Acrylic coated CTA films (coated side in | | |
| contact with PVA) | 7.3 ± 2.4 | 307 ± 7 |
| 5. Acrylic coated CTA films (coated side | | |
| not in contact with PVA) | 7.5 ± 1.8 | 309 ± 9 |

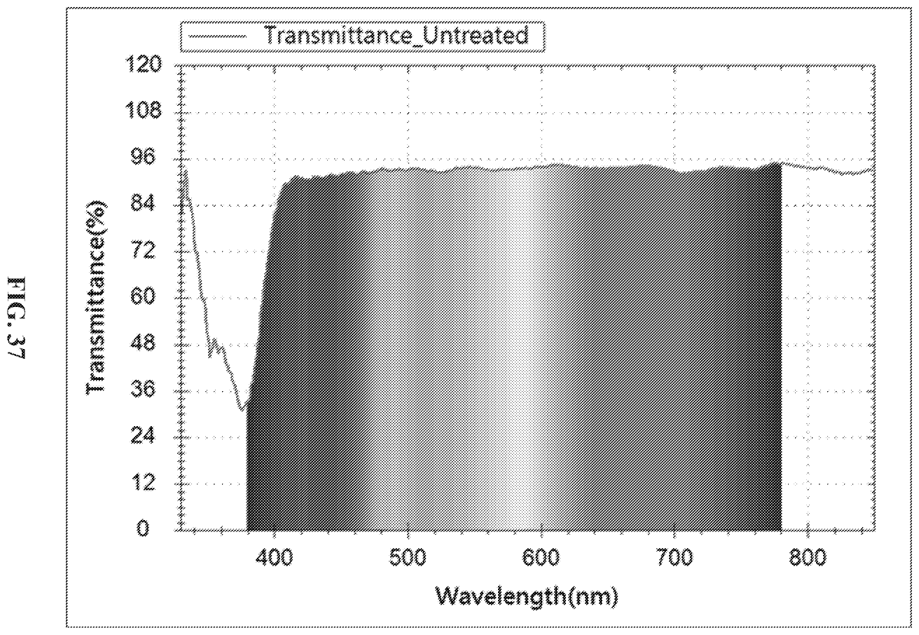

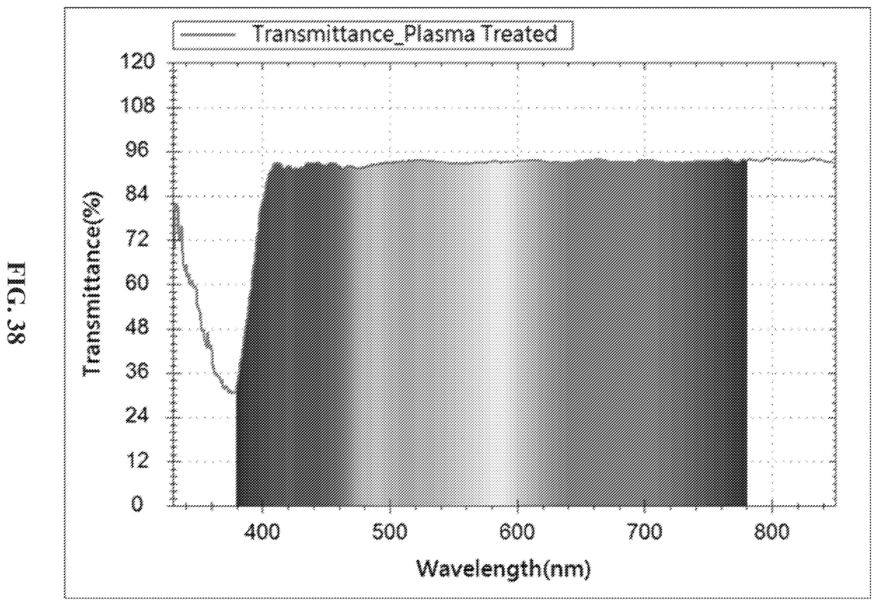

Table 14 shows the light transmittance of CTA films measured by the PROBE Spectroscopy System from ANTAS Technology Corp. FIG. 37 and FIG. 38 show the light transmittance of untreated and O₂ plasma treated CTA film measured at 330-850 nm. There was no significant difference in light retardation observed at 450 nm, 550 nm and 650 nm for O₂ plasma treated, saponified, and acrylic coated CTA films. However, CTA films coated with Acronal S 504, an acrylic latex, show significant retardation at 450 nm meaning that the transparency of CTA films coated with acrylic latex are worse than O₂ plasma treated, saponified, and acrylic coated CTA films.

TABLE 14
Light Transmittance (%) of CTA films

| | Light Transmittance (%) | | |
|---|---|---|---|
| | 450 nm | 550 nm | 650 nm |
| Untreated | 91.84 ± 0.22 | 93.48 ± 0.17 | 93.42 ± 0.64 |
| O₂ Plasma treated | 92.03 ± 0.36 | 92.56 ± 0.63 | 93.52 ± 0.74 |
| Saponified | 91.98 ± 0.52 | 93.31 ± 0.55 | 93.46 ± 0.39 |
| Acrylic coated | 91.57 ± 0.31 | 93.25 ± 0.33 | 92.74 ± 0.29 |
| Acronal S 504 coated | 85.40 ± 0.71 | 91.30 ± 0.23 | 91.80 ± 0.44 |

Adhesion of PVA and CTA (peel adhesion by pulling it at 180° angle at a constant speed using an Instron tester) of plasma-modified CTA films with and without the saponification process using standard PSA's provided by Eastman: A PVA film was laminated with two CTA films under high temperatures and pressures. Table 15 shows the adhesion of lab-made PVA films sandwiched by two CTA films. The specimens were laminated using a hot press at a series of temperatures and pressures to determine the optimized condition. Based on the delaminated area, the adhesion between PVA and CTA at a set of temperatures and pressures is classified into: no adhesion (less than 20% adhesion area), weak adhesion (20-50% adhesion area), moderate adhesion (50-80% adhesion area), and good adhesion (more than 80% adhesion area).

TABLE 15
PVA Lab-Made Film Adhered to CTA Films
(solution dried on flat plate mold at RT)

| | | Pressure | | |
|---|---|---|---|---|
| | Temp. | 5 klb | 10 klb | 15 klb |
| Untreated | 23° C. | N | N | N |
| | 50° C. | W | W | W |
| | 100° C. | M | M | G |
| Plasma | 23° C. | N | N | N |
| Treated | 50° C. | W | W | M |
| | 100° C. | M | G | G |
| Saponified | 23° C. | N | N | N |
| | 50° C. | W | W | M |
| | 100° C. | M | G | G |

N: no adhesion;
W: weak adhesion;
M: moderate adhesion;
G: good adhesion

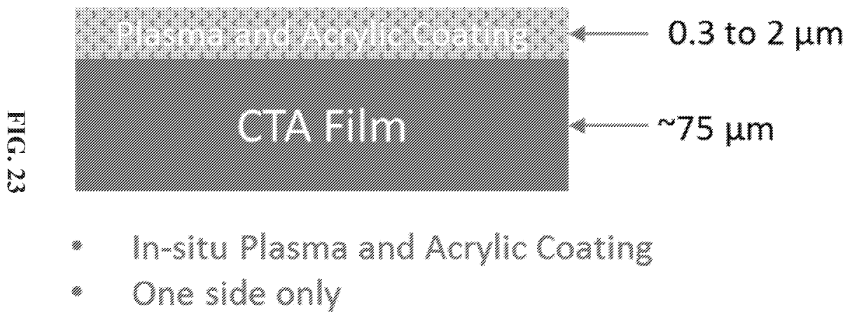

According to Table 16, good adhesion can be obtained at 100° C. and 25 klb hot press condition for untreated, plasma treated and saponified CTA films. The results of a T-peel test of lab-made PVA and CTA films are shown in FIG. 25.

Unlike PVA solution, the specimens made from lab-made PVA films shows no air bubbles inside the specimen. Lab-made PVA film laminated with CTA films also shows better adhesion than those prepared from PVA solution. Further, a commercial PVA film (551 Sol-U-Film) was used for laminating with CTA films. The adhesion of the commercially available PVA film (551 Sol-U-Film) with CTA films is given in Table 16.

TABLE 16
Commercial PVA (551 Sol-U-Film) Adhered to CTA Films

| | | Pressure | | | |
|---|---|---|---|---|---|
| | Temp. | 5 klb | 10 klb | 15 klb | 25 klb |
| Untreated | 23° C. | N | N | N | N |
| | 50° C. | N | N | N | N |
| | 100° C. | W | M | M | M |
| | 120° C. | M | M | M | G |
| Plasma | 23° C. | N | N | N | N |
| Treated | 50° C. | N | N | N | N |
| | 100° C. | M | M | M | M |
| | 120° C. | M | G | G | G |
| Saponified | 23° C. | N | N | N | N |
| | 50° C. | N | N | N | N |
| | 100° C. | M | M | M | M |
| | c | M | G | G | G |

N: no adhesion;
W: weak adhesion;
M: moderate adhesion;
G: good adhesion

According to Table 16, good adhesion can be obtained at 120° C., and 25 klb hotpress condition for untreated, plasma treated and saponified CTA films. Both temperature and pressure required to prepare commercial PVA film are higher than that of lab-made PVA film. This is because the commercially available PVA films have rougher surface than lab-made PVA films, so higher temperature and pressure is required to maintain good contact between PVA and CTA films.

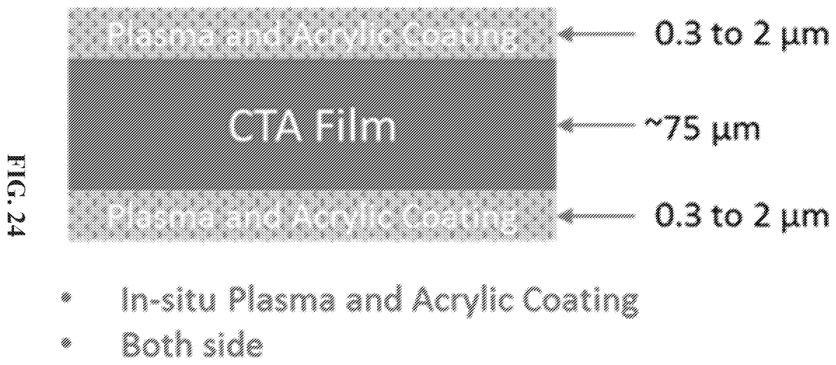

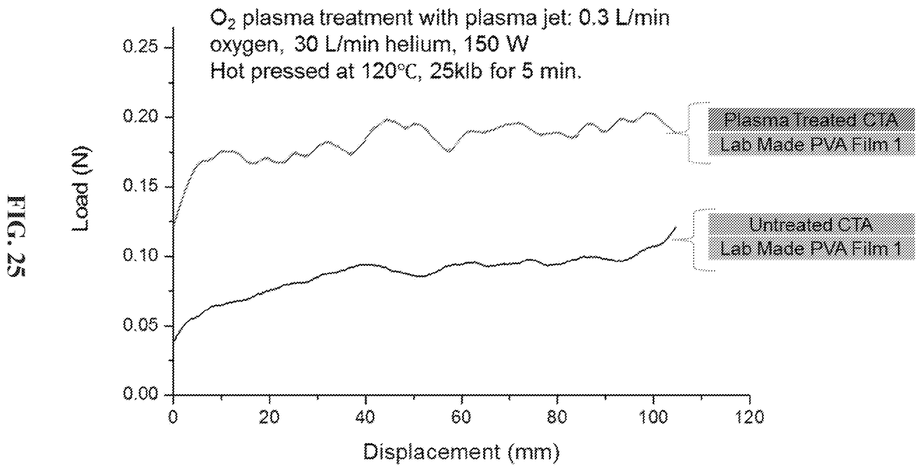

In FIG. 26, the adhesion of PVA films with the O₂ plasma treated CTA film were studied. It was found that an increase in oxygen flow rate increases the adhesion of PVA films with the O₂ plasma treated CTA film. 0.9 L/min oxygen flow rate shows higher adhesion than 0.6 L/min oxygen at 150 W, 30 L/min helium flow rate. The adhesion achieved at 0.9 L/min oxygen flow rate is higher than the adhesion of a PVA film and a saponified CTA film indicating that O₂ plasma treatment can achieve similar or better adhesion than saponification.

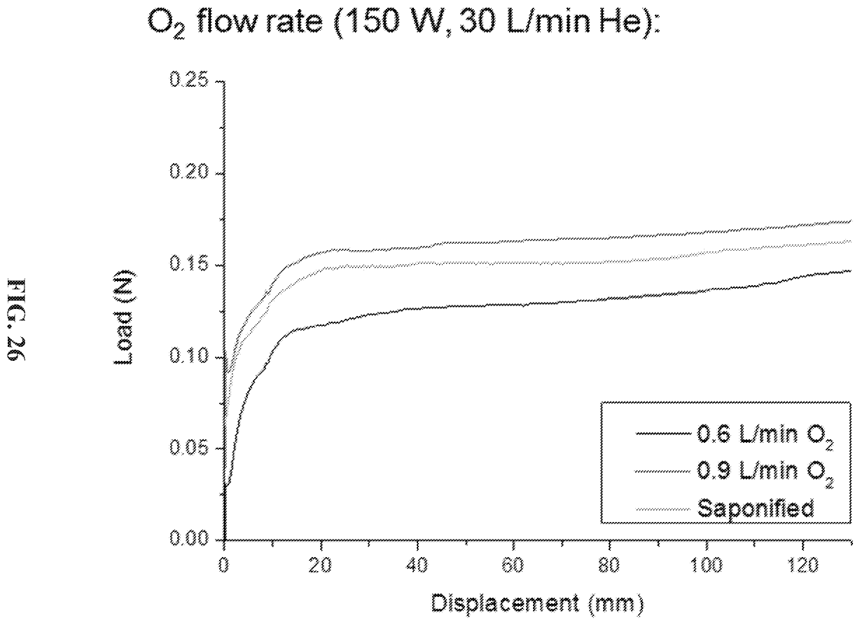

With 0.9 L/min oxygen and 30 L/min helium flow rate, plasma power was adjusted to study its effect on the adhesion. According to FIG. 27, an increase in plasma power leads to an increase in adhesion. However, at 200 W, deformation of CTA films was observed due to heating of film. This can be controlled either by reducing plasma power or by increasing gap between sample and plasma jet. The change in plasma power is considered to be an easy way to control the adhesion of PVA with CTA films. For CTA films treated with 175 W O₂ plasma, the adhesion is close to that of saponified CTA films.

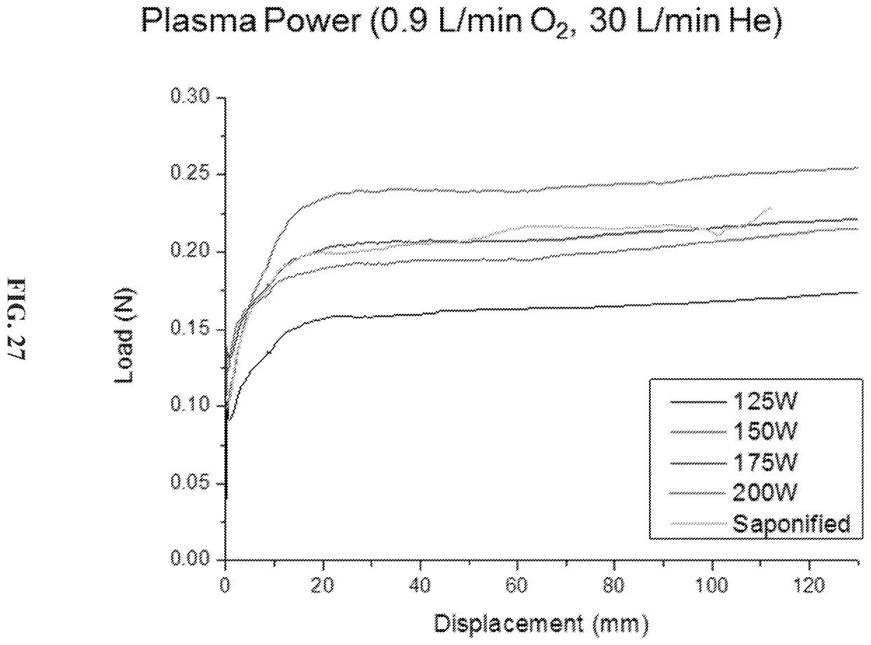

Treatment time (or treatment circle for plasma jet) was studied in FIG. 28. It was found that the adhesion of CTA films with twice plasma treatment exhibit higher adhesion than those with once plasma treatment.

Table 17 lists the measured data from FIGS. 26-28. Once the curve is stable, an average value is obtained from the stabilized region of the curve. Three average values were used to calculate the average adhesion and standard deviation.

TABLE 17
Adhesion of PVA film with plasma treated CTA film

| | O₂ flow | Plasma | Treatment | | Contact |
|---|---|---|---|---|---|
| PVA Film 3 | rate | Power | Time | Adhesion | Angle |
| Adhesion to | (L/min) | (Watt) | (Cycles) | (N) | (°) |
| Saponified CTA | N/A | N/A | 1 | 0.206 ± 0.102 | 35.2 ± 5.2 |
| O₂ Plasma | 0.6 | 150 | 1 | 0.148 ± 0.212 | 38.5 ± 4.6 |
| Treated CTA | 0.9 | 150 | 1 | 0.213 ± 0.225 | 37.9 ± 4.2 |
| | 0.9 | 125 | 1 | 0.151 ± 0.143 | 36.2 ± 3.8 |
| | 0.9 | 150 | 1 | 0.213 ± 0.225 | 37.9 ± 4.2 |
| | 0.9 | 175 | 1 | 0.220 ± 0.135 | 38.1 ± 5.3 |
| | 0.9 | 200 | 1 | 0.254 ± 0.140 | 36.4 ± 8.2 |
| | 0.9 | 175 | 1 | 0.220 ± 0.135 | 38.1 ± 5.3 |
| | 0.9 | 175 | 2 | 0.250 ± 0.312 | 35.5 ± 5.2 |

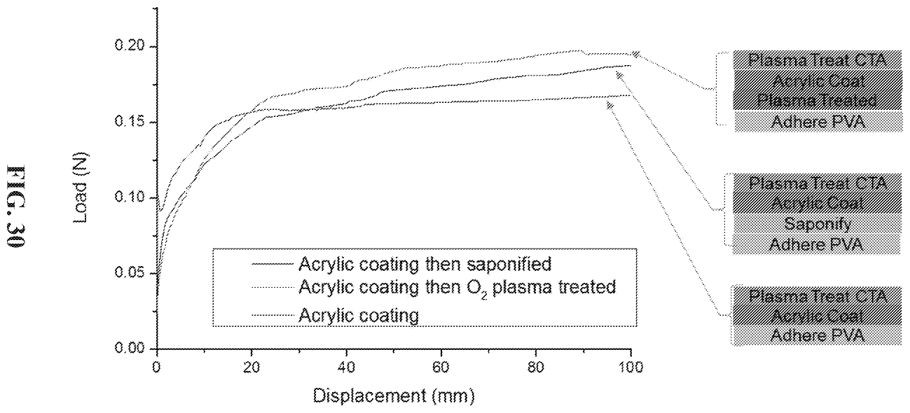

Since both O₂ plasma treatment and saponification lead to an increase in adhesion, the adhesion of O₂ plasma treated then saponified CTA film to PVA film was studied. FIG. 31 indicates that the adhesion of O₂ plasma treated then saponified CTA film has a similar adhesion to that of CTA films that have only undergone saponification. The final surface treatment appears to be the treatment that determines the adhesion of the CTA films. FIG. 30 shows the adhesion of O₂ plasma treated acrylic coated CTA films has similar adhesion to acrylic coated CTA films with saponification.

Adhesion of PSA to CTA: The adhesion of CTA films to pressure sensitive adhesives (PSAs) was measured using the 90-degree peel test that follows ASTM D3300 Standard Test Method for Peel Adhesion of Pressure-Sensitive Tape. Since CTA film and PSA tapes are different in flexibility, 90-degree peel test was chosen instead of T-peel test. ASTM standard PSA test tape, as well as Eastman PSA tape, was used to study the adhesion between CTA films. The adhesion was measured at 23° C. and 50% RH using the Instron tensile tester (Model 4443) installed with an angled fixture (Material Testing Technology Co. Model PSTC.00006.11).

CTA films were fixed on an aluminum board by taping the edge to the aluminum board so that deformation can be controlled while peeling. Eastman PSA tapes were cut into a 1×12-inch strip.

Eastman PSA tape is a PSA adhesive film sandwiched by two release liner tapes. On one side easy to release T-10 tape and on the other side harder to release T-50 tape is removed. The T-10 release film was removed from the Eastman PSA tape, then the Eastman PSA with T-50 was adhered to untreated, O₂ plasma treated, and saponified CTA films to measure the WVTR.

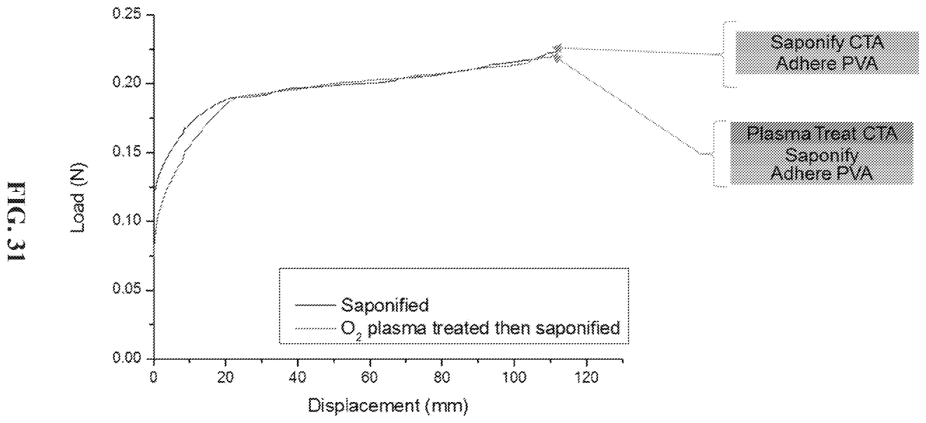

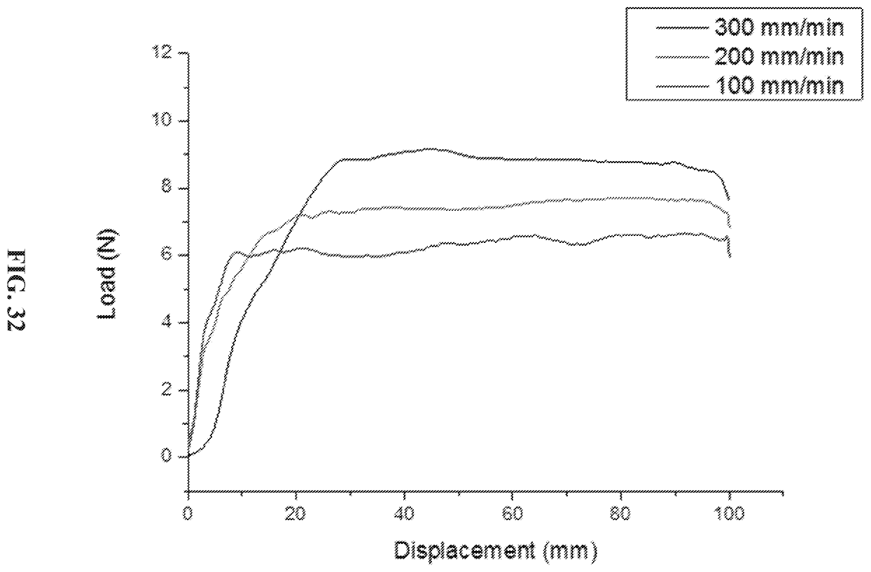

The 90-degree peel tests were conducted at 100, 200, and 300 mm/min peel rate. According to FIG. 32, the adhesion force increases as the peel rate increases. Since 300 mm/min is suggested by ASTM standard. All the 90-degree peel test mentioned in the following analysis will be those conducted under 300 mm/min peel rate.

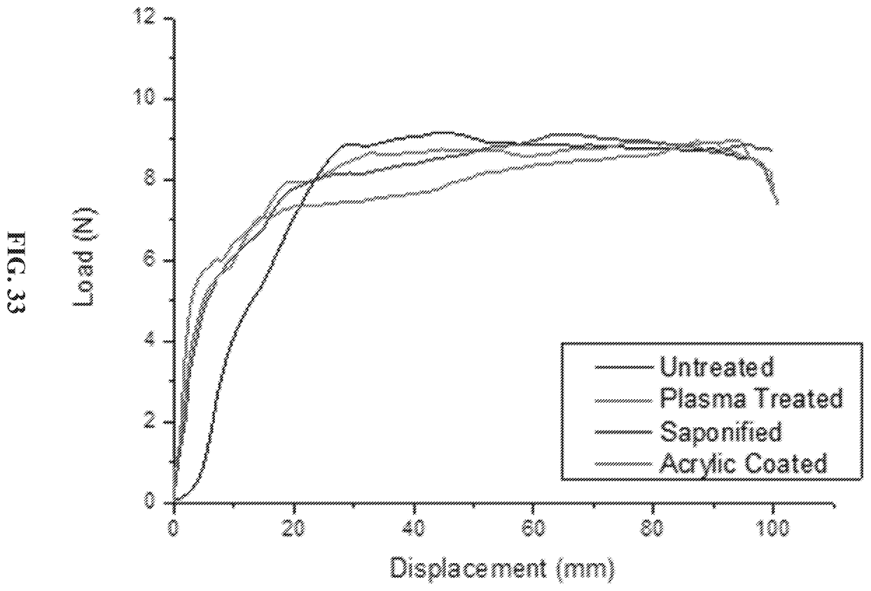

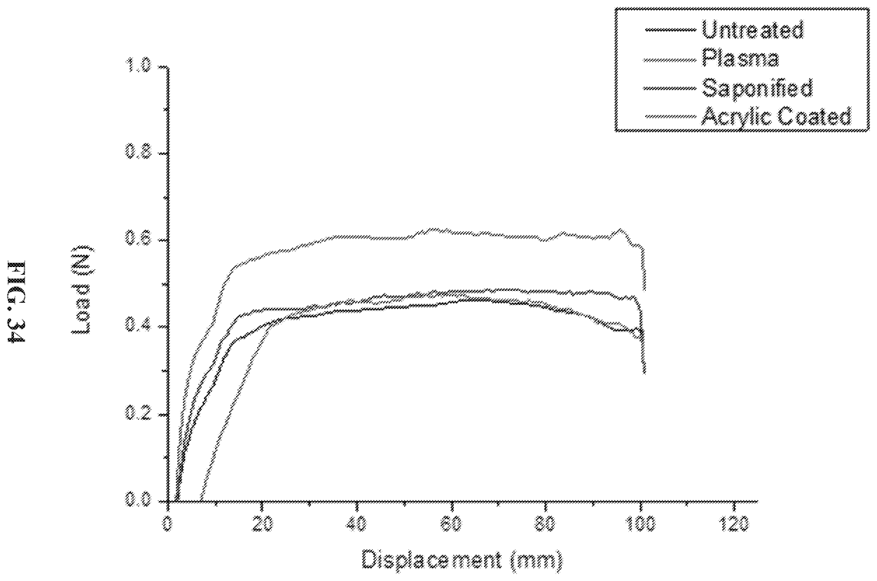

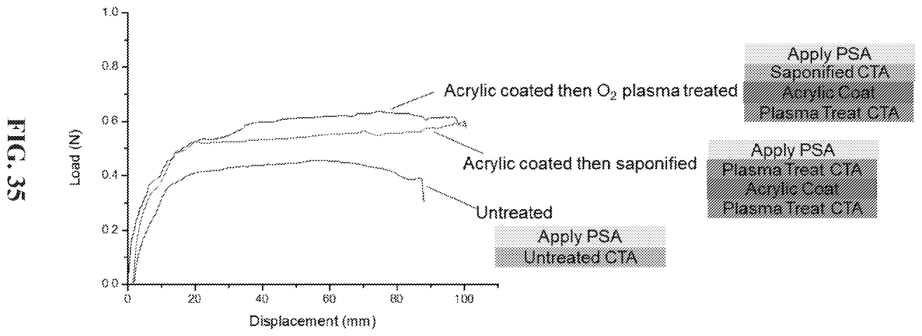

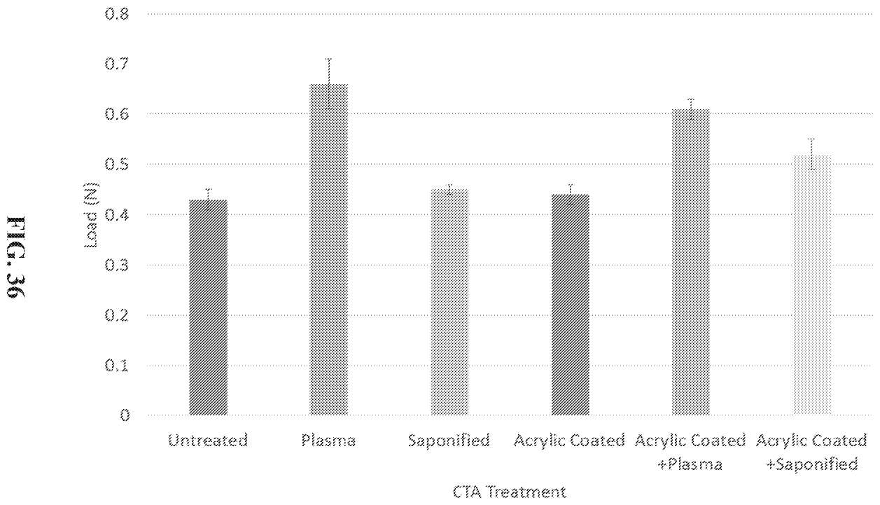

The adhesion of untreated, plasma treated, saponified, and acrylic coated CTA films to ASTM standard PSA tape was measured as shown in FIG. 37. FIG. 36 shows the adhesion of untreated, O₂ plasma treated, saponified, acrylic coated, acrylic coated then O₂ plasma treated, and acrylic coated then saponified CTA films. Each type of sample was measured at least 3 times to obtain the error range of the measurement. There was no significant difference seen between the adhesion of untreated, plasma treated, saponified and acrylic coated CTA films potentially due to the strong adhesion of ASTM standard PSA tape. FIG. 34 shows the adhesion of untreated, plasma treated, saponified and acrylic coated CTA films to the Eastman PSA tape. As shown in FIG. 35, CTA films treated by O₂ plasma exhibit stronger adhesion to the Eastman PSA tape, while there is little difference between the adhesion of untreated, saponified and acrylic coated CTA films to the Eastman PSA.

Since both O₂ plasma treatment and saponification lead to an increase in adhesion, the adhesion of O₂ plasma treated then saponified. CTA film to PSA tapes was also studied using modified 90° peel test with Eastman PSA. FIG. 35 indicates that CTA films with acrylic coating then O₂ plasma treatment exhibit higher adhesion to the Eastman PSA tape than those with acrylic coating then saponification and untreated CTA films.

Acrylic Coating and. Formulation: The effect of initiators and monomers/crosslinking agents on WVTR and light transmittance of the coated CTA films. The molecular structure, color, and state of the initiators are given in Table 18.

TABLE 18
Molecular structure and color of initiators.

| Name | Abbreviation | Structure | Color |
|---|---|---|---|
| Diphenyl (2,4,6- trimethylbenzolyl) phosphine oxide | TPO | 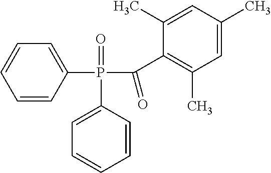 [SMILES: Cc1cc(C)c(C(=O)P(=O)(c2ccccc2)c2ccccc2)c(C)c1] | Yellow Powder |
| 2-hydroxy-2- methylpropiophenone | 1173 | 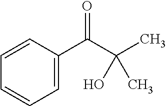 | Clear Liquid |
| 1-hydroxycyclohexyl phenyl ketone | 184 | 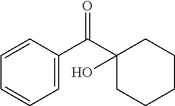 [SMILES: O=C(c1ccccc1)C1(O)CCCCC1] | White Powder |

Both 1173 and 184 are transparent once dissolved in MMA, while TPO solution exhibits slight yellow color.

The WVTRs of acrylic coatings with the three types of initiators are compared in Table 19. 1173 initiator gave lower WVTR than the other two initiators.

TABLE 19
WVTR and curing time of acrylic resins with MMA, TEGDA,
TMPTA, and PETA (1:1:1:1 in volume 2 wt % initiator)

| | Curing Time | WVTR | Coating Thickness |
|---|---|---|---|
| Initiator | (s) | (g/day/m²) | (μm) |
| TPO | >60 | 46.39 ± 0.56 | Less than 3 |
| 1173 | 24-36 | 30.37 ± 1.59 | Less than 3 |
| 184 | 24-36 | 43.45 ± 4.15 | Less than 3 |

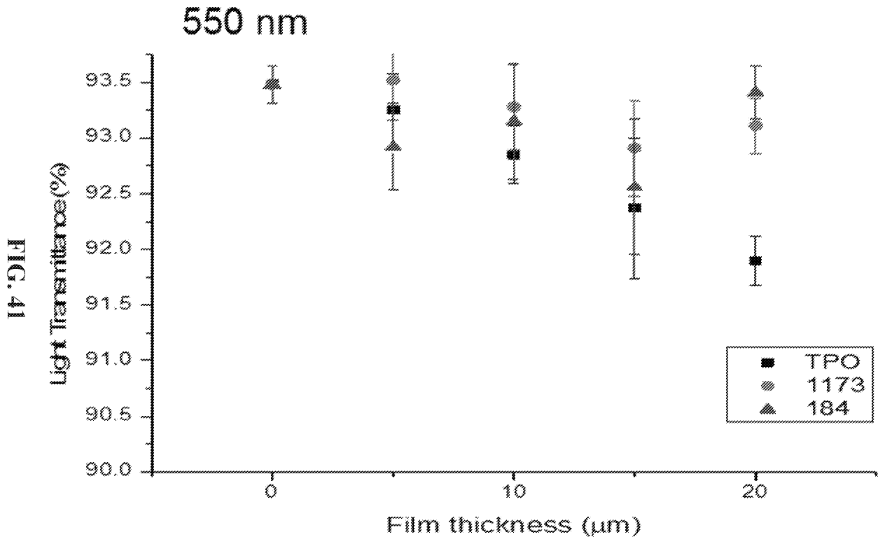

The light transmittance of the acrylic coated CTA films with the three initiators was measured to compare the transparency of the coating. The light retardation (550 nm) as a function of film thickness was given in FIG. 41. It was found that TPO causes slight retardation (2%) of yellow light at 550 nm. For 1173 and 184, no significant light retardation was observed at 450, 550, and 650 nm.

Overall, 1173 initiator provided the lowest WVTR without any negative impact on light retardation. The increase in the number of acrylic groups leads to lower WVTR. The WVTRs of the monomers with 1173 as the initiator are listed in Table 20.

TABLE 20
WVTRs of the monomers with 1173 as the initiator

| | # of Acry. | WVTR | Coating Thickness |
|---|---|---|---|
| Name | Groups | (g/day/m²) | ( μm) |
| MMA | 1 | 49.32 | Less than 3 |
| TEGDA | 2 | 46.66 | Less than 3 |
| DEGDA | 2 | 44.96 | Less than 3 |
| PETA | 3 | 36.28 | Less than 3 |
| TMPTA | 3 | 38.94 | Less than 3 |
| PETA | 4 | 25.61 | Less than 3 |
| CPS Resin | NA | 32.13 ± 4.34 | Less than 3 |

For acrylic resins, polymerization shrinkage occurs due to the density difference between the resin and the polymerized product. Polymerization shrinkage causes deformation of the coated CTA films. Auto-acceleration of radical polymerization generates heat and causes evaporation of monomers resulting in nonuniform or porous coatings, which can reduce the barrier properties of the coating. Pre-polymerization is an initial stage in polymerization that converts monomers into partially polymerized form to control polymerization shrinkage, resin viscosity, molecular weight, and auto-acceleration. Table 21 curing time required for resins with or without pre-polymerization to completely polymerize.

TABLE 21
Curing time required for resins with or without pre-polymerization
to completely polymerize

| | | UV | Curing |
|---|---|---|---|
| Formulation | Pre-Polymerization | source | Time |
| MMA + 1.25 wt % TPO | No | Ultrasonic | 30 sec. |
| | Yes | | 3 sec. |
| | No | LED | 50 min. |
| | Yes | | 4 min. |
| MMA + 1.25 wt % 1173 | No | Ultrasonic | 15 sec. |
| | Yes | | 3 sec. |
| | No | LED | 40 min. |
| | Yes | | 4 min. |
| MMA + 1.25 wt % 184 | No | Ultrasonic | 15 sec. |
| | Yes | | 3 sec. |
| | No | LED | 40 min. |
| | Yes | | 4 min. |

According to Table 21, Pre-polymerization can reduce the curing time because of conversion of monomers to a partially polymerized resin, By coating the pre-polymerized resin, the time required for UV curing can be significantly shortened.

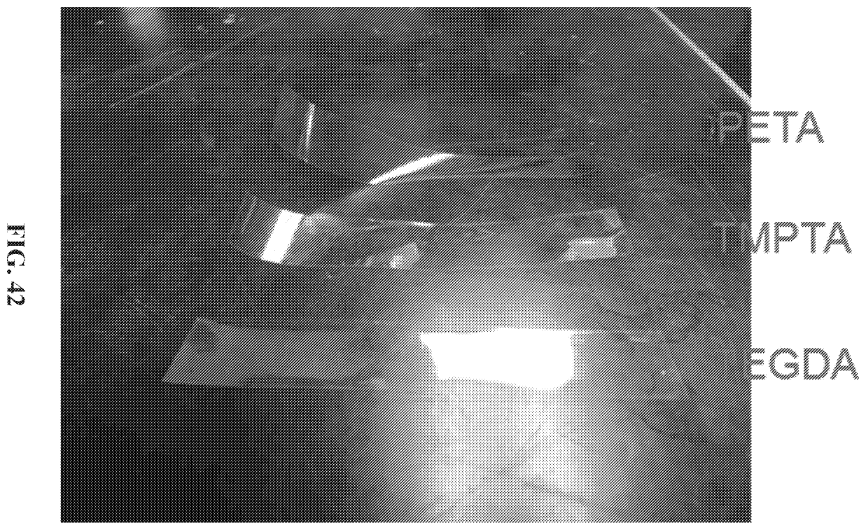

Furthermore, the density difference between pre-polymerized resin and completely polymerized product is smaller than the density difference between monomers and completely polymerized product. The polymerization shrinkage can thus be controlled. FIG. 42 shows the shrinkage of CTA films coated with PETA, TMPTA, and TEGDA. Polymerization shrinkage is controlled by using a monomer or crosslinking agents with more functional groups. Table 22 shows the curing time and WVTR of acrylic monomers coated on CTA films with or without pre-polymerization. It was found that coated CTA films with pre-polymerization have lower WVTRs than those without pre-polymerization. This may be due to the control of monomer evaporation and viscosity. Similar to the results in Table 21, a significant reduction in the final curing time of acrylic resins that were pre-polymerized with LED UV light can be obtained. In addition, a reduction in WVTR with the increased functionality of monomers/crosslinking agents can be seen Table 22.

TABLE 22
Curing time and WVTR of acrylic monomers.

| | 1173 | # of Acry. | Pre-polymerization | Curing Time | | WVTR |
|---|---|---|---|---|---|---|
| Monomers | Initiator | Groups | Time (LED source) | Ultrasonic | LED | g/d.m2 |
| MMA | 1.25% | 1 | No | 30 sec. | 30 min. | 49.32 |
| | | | Yes (20 min.) | 6 sec. | 4 min. | 42.46 |
| TEGDA | | 2 | No | 20 sec. | 5 min. | 46.66 |
| | | | Yes (5 min.) | 6 sec. | 2 min. | 39.86 |
| DEGDA | | 2 | No | 20 sec. | 5 min. | 44.96 |
| | | | Yes (5 min.) | 6 sec. | 2 min. | 38.28 |
| PETA | | 3 | No | 12 sec. | 3 min. | 36.28 |
| | | | Yes (2 min.) | 6 sec. | 1 min. | 32.30 |
| TMPTA | | 3 | No | 12 sec. | 3 min. | 38.94 |
| | | | Yes (2 min.) | 6 sec. | 1 min. | 33.52 |
| PETA | | 4 | No | 12 sec. | 2 min. | 25.61 |

For reasons of completeness, various aspects of the invention are set out in the following numbered clauses:

Clause 1. A film comprising:

a first material comprising a cellulose ester; and

a second material comprising an acrylic coating, the second material applied to at least portion of the first material,

wherein the film has an optical in-plane retardation (Rₑ) of about 0.1 nm to about 2 nm and an out-of-plane retardation (Rₜₕ) of about −5 nm to about −75 nm measured at 598 nm.

Clause 2. The film of clause 1, wherein the first material is a layer having a thickness of about 5 μm to about 100 μm.

Clause 3. The film of clause 1 or 2, wherein the second material is a layer having a thickness of about 0.1 μm to about 25 μm.

Clause 4. The film of any of clauses 1-3, wherein the cellulose ester is selected from the group consisting of cellulose acetate, cellulose triacetate, cellulose propionate, cellulose acetate propionate, cellulose acetate butyrate, cellulose butyrate, cellulose tripropionate, cellulose tri butyrate, and combinations thereof.

Clause 5. The film of any of clauses 1-4, wherein the first material and second material are included at a ratio of about 75:0.5 to about 75:25 (by weight %).

Clause 6. The film of any of clauses 1-5, wherein the acrylic coating comprises a polymer derived from at least one monomer selected from the group consisting of methyl acrylate, ethyl acrylate, propyl acrylate, ethyleneglycol diacrylate, propyleneglycol diacrylate, trimethylolpropane triacrylate, pentaerythritol triacrylate, pentaerythriol tetraacrylate, di-trimethylolpropane tetraacrylate, dipentaerythritol pentaacrylate, methacrylate, methacrylate ditnethacrylate, di(ethylene glycol) dimethacrylate, triethylene glycol ditnethacrylate, methyl methacrylate, ethyl methacrylate, hydroxyethyl methacrylate, and hydroxypropyl methacrylate.

Clause 7. The film of any of clauses 1-6, wherein the film has a water vapor transmission rate of less than or equal to 65 g/day/m² as measured by ASTM E-96 wet cup method.

Clause 8. The film of any of clauses 1-7, wherein the film has a contact angle of about 20° to about 90°.

Clause 9. A polarizing sheet comprising:

a layer comprising a polymer and iodine; and

a film applied on at least a portion of the layer, the film comprising
a first material comprising a cellulose ester, the first material having a surface and having a thickness of 5 μm to about 100 μm; and
a second material comprising an acrylic coating and having a thickness of about 0.1 μm to about 25 μm, the second material applied to at least a portion of the first material's surface.

Clause 10. The polarizing sheet of clause 9, wherein the film has an optical in-plane retardation (Rₑ) of from about 0.1 nm to about 2 nm and an out-of-plane retardation (Rₜₕ) of about −5 nm to about −75 nm measured at 589 nm.

Clause 11. The polarizing sheet of clause 9 or 10, further comprising an adhesive film applied to at least a portion of a surface of the film.

Clause 12. The polarizing sheet of any of clauses 9-11, further comprising a third material applied to at least a portion of the polymer and iodine layer, the third material comprising a cellulose ester.

Clause 13. A method of making a film, the method comprising:
plasma treating at least a portion of a first material comprising a cellulose ester with a plasma composition comprising an inert gas and a reactive gas to provide a plasma-treated surface;
applying a composition to at least a portion of the plasma-treated surface, wherein the composition comprises an acrylic-based monomer and a polymerization initiator; and
curing the composition to provide a second material comprising an acrylic coating positioned on the plasma-treated surface of the first material.

Clause 14. The method of clause 13, wherein the reactive gas has a flow rate of about 0.05 L/min to about 2 L/min during plasma treating.

Clause 15. The method of clause 13 or 14, wherein the inert gas and the reactive gas have a ratio of flow rate of about 5:1 to about 800:1 during plasma treating.

Clause 16. The method of any of clauses 13-15, wherein the composition has a viscosity of about 10 cP to about 1000 cP at 20° C.

Clause 17. The method of any of clauses 13-16, wherein the plasma treating is performed at atmospheric pressure.

Clause 18. The method of any of clauses 13-17, wherein the acrylic-based monomer includes a mono-functional acrylic-based monomer, a di-functional acrylic-based monomer, a tri-functional acrylic-based monomer, a polyfunctional acrylic-based monomer, or combinations thereof.

Clause 19. The method of any of clauses 13-18, wherein the first material following plasma-treatment has an increase in crystallinity of at least 1% relative to a first material that is not plasma treated.

Clause 20. The method of any of clauses 13-19, wherein the composition is applied by a glass, a rod, a blade, a roll, a spray coater, a spin coater, a curtain coater or a dip coater.

Clause 21. A method of making a film, the method comprising:
applying a composition comprising an acrylic-based monomer and a polymerization initiator to a first material comprising a cellulose ester; and
plasma treating the composition and the first material to provide a second material comprising an acrylic coating applied to at least a portion of the first material.

Clause 22. A method of making a polarizing sheet, the method comprising:
plasma treating at least a portion of a first material comprising a cellulose ester with a plasma composition comprising an inert gas and a reactive gas to provide a plasma-treated surface;
applying a composition to at least a portion of the plasma-treated surface, wherein the composition comprises an acrylic-based monomer and a polymerization initiator;
curing the composition and the first material to produce a film;
laminating the film and a layer comprising a polymer and iodine to provide a polarizing sheet.

Clause 23. The method of clause 22, further comprising:
laminating a fourth material to the layer comprising the polymer and iodine opposite that of the film.

Clause 24. The method of clause 23, further comprising:
laminating an adhesive film onto the film;
laminating a release film onto the adhesive film; and
laminating a protective film onto the fourth material.

What is claimed is:

1. A film comprising:
a first material comprising a cellulose ester; and
a second material comprising an acrylic coating, the second material applied to at least a portion of the first material,
wherein the film has an optical in-plane retardation (Rₑ) of about 0.1 nm to about 2 nm and an out-of-plane retardation (Rₜₕ) of about −5 nm to about −75 nm measured at 598 nm.

2. The film of claim 1, wherein the first material is a layer haying a thickness of about 5 μm to about 100 μm.

3. The film of claim 1 or claim 2, wherein the second material is a layer having a thickness of about 0.1 μm to about 25 μm.

4. The film of any of claims 1-3, wherein the cellulose ester is selected from the group consisting of cellulose acetate, cellulose triacetate, cellulose propionate, cellulose acetate propionate, cellulose acetate butyrate, cellulose butyrate, cellulose tripropionate, cellulose tributyrate, and combinations thereof.

5. The film of any of claims 1-4, wherein the first material and second material are included at a ratio of about 75:0.5 to about 75:25 (by weight %).

6. The film of any of claims 1-5, wherein the acrylic coating comprises a polymer derived from at least one monomer selected from the group consisting of methyl acrylate, ethyl acrylate, propyl acrylate, ethylene glycol diacrylate, propylene glycol diacrylate, trimethvlolpropane triacrylate, pentaerythritol triacrylate, pentaerythriol tetraacry late, di-trimethylolpropane tetraacrylate, dipentaerythritolpentaacrylate, methacrylate, methacrylate dimethacrylate, di(ethylene glycol) dimethacrylate, triethylene glycol dimethacrylate, methyl methacrylate, ethyl methacrylate, hydroxyethyl methacrylate, and hydroxypropyl methacrylate.

7. The film of any of claims 1-6, wherein the film has a water vapor transmission rate of less than or equal to 65 g/day/m² as measured by ASTM E-96 wet cup method.

8. The film of any of claims 1-7, wherein the film has a contact angle of about 20° to about 90°.

9. A polarizing sheet comprising:
a layer comprising a polymer and iodine; and
a film applied on at least a portion of the layer, the film comprising
a first material comprising a cellulose ester, the first material having a surface and having a thickness of 5 μm to about 100 μm; and
a second material comprising an acrylic coating and having a thickness of about 0.1 μm to about 25 μm, the second material applied to at least a portion of the first material's surface.

10. The polarizing sheet of claim 9, wherein the film has an optical in-plane retardation (R_{c}) of from about 0.1 nm to about 2 nm and an out-of-plane retardation (Rₜₕ) of about −5 nm to about −75 nm measured at 589 nm.

11. The polarizing sheet of claim 9 or claim 10, further comprising an adhesive film applied to at least a portion of a surface of the film.

12. The polarizing sheet of any of claims 9-11, further comprising a third material applied to at least a portion of the polymer and iodine layer, the third material comprising a cellulose ester.

13. A method of making a film, the method comprising:
plasma treating at least a portion of a first material comprising a cellulose ester with a plasma composition comprising an inert gas and a reactive gas to provide a plasma-treated surface;
applying a composition to at least a portion of the plasma-treated surface, wherein the composition comprises an acrylic-based monomer and a polymerization initiator; and
curing the composition to provide a second material comprising an acrylic coating positioned on the plasma-treated surface of the first material.

14. The method of claim 13, wherein the reactive gas has a flow rate of about 0.05 L/min to about 2 L/min during plasma treating.

15. The method of claim 13 or claim 14, wherein the inert gas and the reactive gas have a ratio of flow rate of about 5:1 to about 800:1 during plasma treating.

16. The method of any of claims 13-15, wherein the composition has a viscosity of about 10 cP to about 1000 cP at 20° C.

17. The method of any of claims 13-16, wherein the plasma treating is performed at atmospheric pressure.

18. The method of any of claims 13-17, wherein the acrylic-based monomer includes a mono-functional acrylic-based monomer, a di-functional acrylic-based monomer, a tri-functional acrylic-based monomer, a polyfunctional acrylic-based monomer, or combinations thereof.

19. The method of any of claims 13-18, wherein the first material following plasma-treatment has an increase in crystallinity of at least 1% relative to a first material that is not plasma treated.

20. The method of any of claims 13-19, wherein the composition is applied by a glass, a rod, a blade, a roll, a spray coater, a spin coater, a curtain coater or a dip coater.

21. A method of making a film, the method comprising:
applying a composition comprising an acrylic-based monomer and a polymerization initiator to a first material comprising a cellulose ester; and
plasma treating the composition and the first material to provide a second material comprising an acrylic coating applied to at least a portion of the first material.

22. A method of making a polarizing sheet, the method comprising:
plasma treating at least a portion of a first material comprising a cellulose ester with a plasma composition comprising an inert gas and a reactive gas to provide a plasma-treated surface;
applying a composition to at least a portion of the plasma-treated surface, wherein the composition comprises an acrylic-based monomer and a polymerization initiator;
curing the composition and the first material to produce a film; and
laminating the film and a layer comprising a polymer and iodine to provide a polarizing sheet.

23. The method of claim 22, further comprising:
laminating a fourth material to the layer comprising the polymer and iodine opposite that of the film.

24. The method of claim 23, further comprising:
laminating an adhesive film onto the film;
laminating a release film onto the adhesive film; and
laminating a protective film onto the fourth material.
